(19) United States
(12) Patent Application Publication
(10) Pub. No.: US 2006/0123055 A1
(43) Pub. Date: Jun. 8, 2006

(54) Device and method for selectively controlling the utility of a target

(76) Inventors: Paul Atkinson, San Diego, CA (US); Ronald S. Conero, San Diego, CA (US)

Correspondence Address: WILLIAM J. KOLEGRAFF, 3119 TURNBERRY WAY, JAMUL, CA, 91935, US

(21) Appl. No.: 11/296,081

(22) Filed: Dec. 7, 2005

Related U.S. Application Data
(60) Provisional application No. 60/633,971, filed on Dec. 7, 2004.
(60) Provisional application No. 60/654,384, filed on Feb. 18, 2005.

(51) Int. Cl. G06F 17/00; G06F 7/00

(52) U.S. Cl. 707/104.1

(57) ABSTRACT

A radio frequency controller device enables the utility of a target to be controlled using an RF communication. The radio frequency controller device has a switch that is set to a defined state responsive to the RF communication. More particularly, conditional logic circuitry uses the RF communication to determine if the target's utility should be changed, and sets the state of the switch accordingly. The radio frequency controller device also has a target interface that allows the target to determine the state of the switch, and based on the state of the switch, a different utility will be available for the target. The radio frequency controller device also has an antenna for the RF communication, as well as a demodulator/modulator circuit. When used to control the utility of an electrical or electronic device, the radio frequency controller device has a low-power circuit portion that is used to set the state of the switch responsive to the RF communication, and also has a full power circuit portion that communicates with the target. In this way, the state of the switch may be set when the target is in a power-off condition, and the target is able to determine the state of the switch when the target is activated.

### RELATED APPLICATIONS

The present application claims priority to U.S. provisional patent application 60/633,971, filed Dec. 7, 2004, entitled “A Method and Means of RF Activation of a Target”; to U.S. provisional patent application 60/654,384, filed Feb. 18, 2005, entitled “A Method and Means of RF Activation of a Target”; to U.S. patent application Ser. No. 11/259,578, filed Oct. 26, 2005, entitled “Method and System for Selectively Controlling the Utility a Target”; and to U.S. patent application Ser. No. 11/259,185, filed Oct. 26, 2005, entitled “Method and Network for Selectively Controlling the Utility a Target”, all of which are incorporated herein by reference as if set forth in their entirety. This application is also related to copending U.S. patent application Ser. No. ______, filed ______, and entitled “______”; and to U.S. patent application Ser. No. ______, filed ______, and entitled “______”; which are also incorporated herein by reference.

### BACKGROUND

1. Field

The present invention relates to a target that is enabled to have its utility controlled using RF communication. In a particular example, the invention uses radio frequency (RF) devices and processes to set the level of utility available for durable goods such as electronic devices or optical media.

2. Description of Related Art

Management of the supply chain is a concern for most manufactures, shippers, and retailers. In order to facilitate efficient check-out of products, manufacturers have place bar code labels on many consumer products. In a similar way, manufacturers and shippers have also labeled pallets of products with bar-code labels to increase shipping efficiency. However, bar code readers require a line-of-site reading, so can not, for example, account for products in the middle of a pallet, or for products buried in a consumer's cart. An RFID (radio frequency identification) system overcomes this problem by labeling a product with an RFID tag. The RFID tag is attached to a product, and when interrogated by an associated RF reader, responds with its identification number. In this way, products can be identified and tracked without the need for line of sight scanning. Unfortunately, RFID has been slow to be adopted, due to the relatively high cost of RFID tags themselves, and to limitations in reading the RFID tags. For example, although RFID tags do not need line-of-sight scanning, the RFID tags must be in a position to receive and transmit low-level RF signals. This not only limits where on a product package an RFID label may be placed, but also causes errors when a product is placed in a position where the label is shielded from the RF reader.

Theft is also serious and growing problem in the distribution of products. In one example, electronic devices continue to shrink in size, while increasing their utility. As these electronic devices become smaller and more capable, they also become easier and more attractive to steal. Devices, such as digital cameras, DVD players, MP3 players, and game devices are popular targets of theft, not only in the retail store by consumers, but also by others in the distribution chain. For example, retail store employees, shippers, warehousers, and even employees of the manufacturer often steal products, and even boxes of products, for their own use or to sell. Other types of products are also subject to theft, such as DVDs, CDs, game discs, game cartridges, and other types of media. These types of products are also in high demand, and being relatively small and valuable, are easy and attractive to steal.

From the facility where they are manufactured to the retail point-of-sale (POS) where they are sold many high-value consumer products are vulnerable to theft. Various security techniques are used to minimize the losses (video cameras, security staff, electronic tagging, storing high-value items behind locked cabinets etc.). Despite these efforts theft of high-value targets such as DVD's, CD's and video games; portable video game players, DVD players, digital cameras, computers, printers, televisions and the like cost manufacturers and retailers billions of dollars per year.

Such rampant theft increase the cost of manufacturing, shipping, and selling of products. Each entity in the distribution chain is at risk for theft, and must take steps to reduce or control the level of theft. This cost is ultimately borne by the legitimate purchaser, which places an unfair “theft tax” on purchased products. Also, since may products are so easily stolen from a retail environment, retailers must take extraordinary steps to secure products. For example, DVDs, CDs, and small electronic devices are often packaged in oversized holders to make them more difficult to hide. These holders, however, also interfere with a consumers ability to interact with the product, ultimately making the product less attractive to the consumer. In another example, retail stores may place their most valuable and easily stolen products in locked cases. In this way, retail consumers are completely distanced from these products, which reduces theft, but also makes the products difficult to purchase. The consumer cannot read the full labeling on these locked-up products, can not physically interact with them, and must get the attention of a retail clerk, who might have a key, in order to get to the product. In another attempted solution, retail stores put security tags on products, which are intended to be disabled at the check stand upon purchase. If a consumer leaves the store with a live tag, then an alarm sounds. A guard or clerk is expected to stop the consumer and determine if the consumer has shoplifted a product. This process may be dangerous for the guard or clerk, and, since many of the alarms are false, causes undo stress for law-abiding consumers.

None of these attempts to stop retail theft has worked, and all make the retail experience less attractive to the consumer. In this way, the retailer is in the untenable position of having to accommodate and accept a certain (and sometimes significant) level of theft in order to maintain an attractive and desirable retail environment for paying customers. Further, neither the oversized holders, the locked cases, nor the guards address the significant level of theft that occurs between the manufacturer's dock to the retail shelf. Accordingly, the entire distribution chain has resigned itself to an “acceptable” level of theft, and passes the cost of theft on to the legitimate consumer.

The distribution of products faces other challenges. For example, consumers want to choose products that have a particular set of functions or utility, and find it desirable to purchase products matched to their specific needs. Accordingly, manufacturers often manufacture a product in several difference models, with each model having a different set of features. Although this is desirable from the consumer's standpoint, it complicates the manufacturing, shipping, inventorying, shelving, and retailing processes. This problem exists in the configuration of electronic products, computers, gaming systems, DVDs, CDs, game cartridges, for example. For a specific example, a DVD movie disc may be available in a family version, a theater version, and an “uncut” version. Each has a different age restriction, and will appeal to different and significant markets. Accordingly, three different versions must be manufacture, shipped, inventoried, shelved, and managed. A similar problem exists with feature sets for games, computers, and other products.

Challenges also exist for non-commercial distribution of goods. For example, the military stores, transports, and maintains weapons and gear that is subject to theft and misuse. These weapons and gear must be available for rapid deployment and use, but yet must be sufficiently controlled so that they do not fall into enemy hands, or used in ways not approved by military command.

### SUMMARY

Briefly, the present invention provides a radio frequency controller device that enables the utility of a target to be controlled using an RF communication. The radio frequency controller device has a switch that is set to a defined state responsive to the RF communication. More particularly, conditional logic circuitry uses the RF communication to determine if the target's utility should be changed, and sets the state of the switch accordingly. The radio frequency controller device also has a target interface that allows the target to determine the state of the switch, and based on the state of the switch, a different utility will be available for the target. The radio frequency controller device also has an antenna for the RF communication, as well as a demodulator/modulator circuit. When used to control the utility of an electrical or electronic device, the radio frequency controller device has a low-power circuit portion that is used to set the state of the switch responsive to the RF communication, and also has a full power circuit portion that communicates with the target. In this way, the state of the switch may be set when the target is in a power-off condition, and the target is able to determine the state of the switch when the target is activated.

In one arrangement, the radio frequency controller device has an internal module inside the target, and an external module outside the target. The external module has the antenna, so the antenna is able to robustly provided RF communication. The external module may electrically and mechanically connect to the target through a connector, such as a custom connector, power connector, audio connector, or video connector. In some cases, the connector may not sufficiently pass RF signals, so the RF signal is demodulated to a lower frequency using circuitry on the external module. Also, some standard connectors are likely to connect to target operating circuitry, so an isolation circuit may be useful to properly route signals between the external module and the internal module. The isolation circuit may also be useful to protect radio frequency controller device circuits from effects of the target circuit, as well as protect the target circuits from effects of the radio frequency controller device. The radio frequency controller device may be constructed, for example, as an integrated circuit DIP package, a surface mount package, silicon die, or as a printed circuit.

Advantageously, the disclosed radio frequency controller device enables an RF device to selectively change the utility of a target. The radio frequency controller device may be readily incorporated into targets such as electrical or electronic devices, so enables adaptable manufacturing process, flexible distribution accounting, and a denial-of-benefit security system. Since the radio frequency controller device may be constructed as commonly used surface mount or DIP packages, the radio frequency controller device may be economically installed in many electronic, electrical, and media devices. Also, the radio frequency controller device may be constructed as a single package, or may be constructed as an internal module connected to an external module, which allows for the flexible positioning of device components. In this way, components that need RF communication capability may be placed in areas with improved RF reception. By separating the antenna or other RF-sensitive components from other logic circuitry, more robust detection is enabled. Also, the increased placement flexibility enables an RF control capability for a wider range of products, and allows for a more aesthetically appealing arrangement of components. For example, the externally visible portions of the radio frequency controller device may be made smaller and less intrusive, with the memory and logic portions placed in an out-of-sight location.

### BRIEF DESCRIPTION OF DRAWINGS

FIG. 1 is a block diagram of a radio frequency activation device with controlled utility.

FIG. 2 is a block diagram of a radio frequency activation device with controlled utility.

FIG. 3 is a block diagram of a prior art RFID chip.

FIG. 4 is a block diagram of a process for activating a target.

FIG. 5 is a block diagram of an RFA device.

FIG. 6 is a block diagram of an RFA device

FIG. 7 is a block diagram of an RFA device

FIG. 8 is an illustration of an electronic device with controlled utility having an external antenna member.

FIG. 9 is a diagram of an electronic device with controlled utility having an external antenna member.

FIG. 10 is a diagram of an electronic device with controlled utility having an external antenna member

FIG. 11 is a block diagram of a target activated using an RFA internal device.

FIG. 12 is a block diagram of a target activated using an RFA internal device.

FIG. 13 is a block diagram of a target activated using an RFA internal device.

FIG. 14 is a block diagram of a target activated using an RFA internal device.

FIG. 15 is a block diagram of a target activated using an RFA internal device.

FIG. 16 is a block diagram of a target activated using an RFA internal device.

FIG. 17 is a circuit diagram of a target having controlled utility.

FIG. 18 is a circuit diagram of a target having controlled utility.

FIG. 19 is a circuit diagram of a target having controlled utility.

FIG. 20 is a circuit diagram of a target having controlled utility.

FIG. 21 is a circuit diagram of a target having controlled utility.

FIG. 22 is a circuit diagram of a target having controlled utility.

FIG. 23 is a block diagram of a radio frequency activation device with controlled activation.

FIG. 24 is a block diagram of a radio frequency activation device with controlled activation.

FIG. 25 is a block diagram of a radio frequency identification device.

FIG. 26 is a block diagram of a radio frequency identification device.

### DETAILED DESCRIPTION

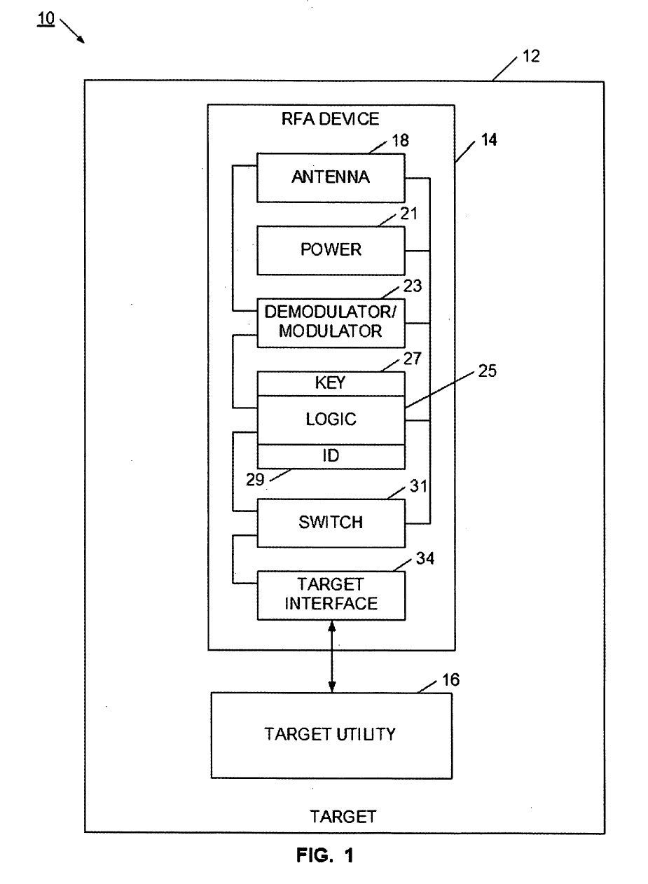

Referring now to FIG. 1, a target device 10 is illustrated. Target device 10 includes a radio frequency activation (RFA) device 14 within the housing 12 of the target. The RFA device is used for controlling the utility of the target 10. To facilitate ease of manufacture, the RFA device 14 is provided in a package convenient for large-scale production. For example, the RFA device may be in the form of an integrated circuit package, or in the form of a surface mount device. Either way, the RFA device may be easily designed into a target's circuitry or logic, and may be readily installed on a printed circuit board or other substrate. In this way, the RFA device may be included with a target device in a cost effective manner. It will be appreciated that the RFA device may be provided in other manufacture-friendly forms.

Target 10 may be an electronic device such as a computer, TV, appliance, MP3 player, camera, game counsel, or toy. In another example, the target may be a tangible media, such as an optical disc, DVD, CD, or game cartridge. During manufacture or preparation of the target 10, the RFA device 14 has been incorporated into the target in a way that allows the RFA device 14 to control the utility of the target. For example, the RFA device 14 has a switch 31 that couples to some utility 16 of the target. The switch is coupled to the utility 16 through the target interface, which may be a logic line, a power line, a control line, a multi-line interface, or a memory location. Also, it will be appreciated that the target interface may be selected according to the physical form of the RFA device. For example, if the RFA device is in an integrated circuit DIP package, then the target interface will include an IC pin coupled to a trace in the target's printed circuit board. In the case of a surface mount form, the target interface will include a pad contact to the printed circuit board or other substrate.

The switch 31 is set by the RFA device according to received data, and is used to control the utility available for the target or for use of the target. More particularly, the switch 31 has multiple states, with each state being associated with an available state of utility for the target. In a specific application, the switch may be switched between two available states of utility. In operation, the RFA device acts as an interface between two distinct systems. First, the RFA device has a low-power RF circuit that is configured to receive data from a low-power RF source, and using power received from the RF source, determine if the target is authorized to have its utility changed. If so, the RFA device, using its low-power circuit, sets the switch to the authorized state. The second system is the full power circuit of the target electronic device. This full power target utility circuit may include, for example, microprocessors, power supplies, memory systems, and other electric and electronic components. The target utility circuit couples to the switch in a way that allows the target utility circuit to act according to the state of the switch. For example, each time the target is activated, the target utility circuit tests the state of the switch, and depending of the switch's state, presents a particular level of utility. Stated more succinctly: the state of the switch is set using a low power circuit, which sets the utility available to the full power circuit. In a typical case, the RFA device will also be powered from the full power circuit. In other cases, the RFA device may remain passive when the target is operating.

When the target 10 enters the distribution chain, the target 10 is set to have one utility. For example, this utility could be a severely comprised utility, where the target has no useful function available. In another example, the utility may be set to a demonstration utility that allows limited demonstration functionality. It will be appreciated that the available utility may be set according the requirements of the specific distribution chain. At some point in the distribution chain, for example, when the target is transferred to a consumer, it may be desirable to change the available utility. Accordingly, when the target in the presence of an activation device at a point-of-sale, the activation device or another reader is able to read an identifier value or other identification from the target. The activation device uses the identifier to generate or retrieve an authorization key. Provided the point-of-sale device has authorization to change the utility of the target, the activation device transmits the authorization key to the RFA device 14. In one example, the activation device reads the ID 29 from the RFA device 14, and transmits the authorization key to the RFA device 14 using an RF (radio frequency) communication. It will be appreciated that other types of wireless communication may be used. For example, the communication may use infrared (IR) communication in one or both directions. In another example, the target may make physical contact with the activation device for effecting the communications.

The RFA device 14 uses the received authorization key to set the switch 31 to another state. Then, when the consumer tries to use the target 10 in its full-power state, the target utility 16 is able to function according to the new state set in switch 31. In this switch state, the target has a different utility than when the switch was in the first state, which is typically a fully-functioning state. The RFA device 14 has logic 25 coupled to the switch 31 that uses the authorization key to effect a change the switch 31. In one example, the RFA device 14 has a restricted access key 27 that was defined and stored with the RFA device 14 during the manufacturing process for the target 10. This restricted access key may not be externally read, altered, or destroyed, but may be read or otherwise used by the RFA logic 25. This restricted access key 27 may be compared or otherwise used with the received authorization key to determine if the RFA device 14 is enabled to change states of the switch 31.

In a specific example of target 10, target 10 is illustrated to be an MP3 player. During manufacture of the MP3 target device, an RFA device is installed in the MP3 player. The RFA device may be, for example, an RFA integrated circuit DIP device, a surface mount device, or other circuit module. In the case where the RFA device is a surface mount device, the RFA device is applied to a circuit board of the player in a way that the RFA switch 31 is able to control a utility function 16 of the player. For example, the RFA device may connect to the power source of the player's operational circuitry so that the player will not function until the switch is changed. In another example, the RFA device couples to the decoder processor in the player, and restricts the ability of the player to properly play music files until the switch is in a proper position. In yet another example, the RFA device may couple to the processor, and restrict the options available in the user interface until the switch is in the proper position. In this way, the player may have a limited demonstration interface until the full user interface is enabled by changing the switch. A restricted access key is also stored in the RFA device, and the switch 31 is set to a state so that the MP3 player's utility is compromised.

The MP3 player is thereby manufactured and ready for sale as a compromised MP3 player that will not properly power-on or function. In this way, the compromised MP3 player would be nearly useless to a consumer, and therefore would be less likely to be a target of theft. The manufacturer has also stored an accessible identification 29 in the RFA device. In some cases, the identification may be pre-stored in the RFA device, and in others, the manufacturer will assign the ID during the manufacturing process. For example, the accessible identifier may be a stored value that is accessible through, for example, an RFID reader system. The compromised MP3 player may be shipped through the distribution chain and to the retailer with a substantially reduced threat of theft. Also, the retailer may display and make the MP3 player available for customer handling in a retail environment with reduce risk of theft. In this way, reduced security measures may be taken at the retail level, such as using locked cases or sophisticated packaging, since the consumer would obtain no benefit by stealing a nonworking, compromised MP3 player.

When a consumer decides to purchase the MP3 player, the consumer may take the MP3 player to the point-of-sale terminal and have it passed proximally to an activation device. As the MP3 player is close to the activation device, its accessible ID 29 is read by the activation device by retrieving the stored accessible ID using a wireless or EM (electromagnetic) communication. For example, the communication may be an RF (radio frequency) communication. The communication from the point-of-sale device to the RFA device 14 is though antenna 18. In one arrangement, antenna 18 is able to both receive and transmit data to the point of sale terminal. The point-of-sale terminal may have a network connection to an operation center, and sends the accessible ID value to the operation center. The operation center, which has a database of RFA device identifications associated with their restricted access keys, retrieves the particular authorization key for the RFA device in the MP3 player that is at the point-of-sale device. At the point-of-sale terminal, additional confirmation actions may be taking place. For example, a clerk may be accepting payment from the consumer, or may be checking a consumer's identification or age. These other confirmation criteria may then be used to confirm that the point-of-sale terminal is ready to restore the utility of the MP3 player. Provided the activation device determines restoration is appropriate, the activation device transmits the authorization key to the RFA device using a wireless communication. The RFA device 14 receives the authorization key, and using its logic 25, compares the authorization key to its pre-stored restricted access key 27. If the keys match, then the RFA device 14 uses its low-power source to change the state of the switch 31. In the new state, the target utility 16 is fully available to consumer.

In another example, the consumer purchases the MP3 player from an online retailer, and the MP3 player is shipped or mailed to the consumer. In this scenario, several alternatives exist as to where the utility for the MP3 player may be restored. In one alternative, the online retailer has an activation device in their warehouse or shipping department, and a retail employee restores the utility to the MP3 player as part of the shipping process. In another alternative, the MP3 player is shipped with compromised utility, and the shipper has an activation device that they use to restore utility prior or at the time of delivery. In this alternative, the driver of the delivery truck may restore utility as the consumer accepts the MP3 player, thereby removing risk of theft during the entire shipping process. In a final alternative, the consumer has a home activation device, and the consumer uses the activation device to restore utility to the MP3 player. In this last alternative, the MP3 player is in a compromised utility from the manufacturer all the way to the consumer's location, and it is the consumer, after the commercial transaction is complete, that finally restores utility to the MP3 player.

In some cases, the RFA device may have additional circuitry for confirming that the utility has been restored. For example, the state of the switch may be measured, or another test or measurement may be taken. According to whether or not the switch was set successful, a different value may be placed in a confirmation memory. The confirmation memory may be read by an activation device to confirm to the consumer and to the network operations center that activation was successful. By confirming successful activation, the retailer may have a higher degree of confidence of consumer satisfaction, and may accurately and timely report and authorize payment to the supplier of the MP3 player.

RFA device 14 is constructed to receive an authorization key via a demodulator/modulator 23. Demodulator/modulator 23 may be a wireless communication circuit, such as a radio frequency or electromagnetic receiver. The RFA device 14 has logic 25 which is configured to receive the authorization code and make a determination if the switch 31 should have its state changed. The logic 25 may include logic structures as well as dynamic or non-volatile memory. In one example, logic 25 uses a target key 27 in making the determination of whether or not the switch can change to another state. In one example, target key 27 has been stored during the manufacturing process in a manner that is not readable using external devices. For example, target key 27 may be placed in a nonvolatile, non erasable and non alterable memory of the RFA device during manufacture. This target key may be the same value as the authorization key, so the logic simply performs a comparison between the restricted access target key 27 and the received authorization key to determine if the switch 31 of the RF device may be changed. It will be understood that other logical processes may be used in making this determination. Provided the logic 25 determines the switch 31 may be changed, the logic causes the switch 31 to change states. In one example, the switch 31 is a change effecting device. The change effecting device may be, for example, an electronic switch, an electrical switch, a fuse, a conditional break in a trace, a logical state, or may be a set of values defined in a memory location. In another example, the change effecting device is an electrically switchable optical material such as electrochromic material. It will be appreciated that other devices may be used for the change effecting device.

The change effecting device may change state upon the application of an activation power, or may use logical process to set or change values stored in memory. The activation power 21 may be, for example, a separate battery which powers the logic 25, the demodulator/modulator 23, and the switch 31. In another example, the activation power 21 may be a converter for converting a received radio frequency or electromagnetic energy into available power. Also, the activation power may be wholly or partially obtained from a source external to the target. It will be appreciated that other electronic components may be necessary to implement such a converter. In another example, activation power may be provided by the operational power for the full device. For example, if the full device is an MP3 player, and the MP3 player has an operational rechargeable battery, the rechargeable battery may have sufficient initial charge to power the RFA device while the target is in the distribution chain. In yet another example, activation power may be provided by multiple power sources. For example, a small battery may power the change effecting device, while an RF or EM converter device may power the logic and communication circuit. It will be appreciated that many options and alternatives exist for powering the circuitry within the RFA device 14.

RFA device 14 may have a confirmation circuit or memory with logic 25 which changes state according to the actual or probable state of the switch 31. In some cases, the actual state of the switch may be detected, or the actual state of the switch may be measured. In other cases, the actual states may not be conveniently measured or detected, so some aspect of the change process may be measured or detected instead. In this case, a confirmation that change process was being successfully performed leads to a high probability that the utility of the target was also successfully changed. Accordingly, the confirmation logic may directly detect the state of the switch 31, or may have measured the electrical processes used in making the change. For example, the current passing through a fuse may be measured, and thereby confirm that a sufficient amount of electricity has passed through the fuse to cause it to break. Although not a direct detection of the state of the switch, it is highly probable that the state of the fuse has changed, resulting in a change of state in the switch. In another example, logic 25, and may confirm that logical processes were properly performed for setting the switch. In another example, logic 25 may directly connect to the utility means 16 itself, to confirm that the switch changed. Once logic 25 receives confirmation that the switch changed, that confirmation signal may be communicated to an activator device using a transmitter, or may be read responsive to a request from the activator. The RFA device 14 may therefore provide feedback to the activation and distribution control system to confirm that utility has been changed. This information may then be used to generate reports or to initiate payment to parties within the distribution chain.

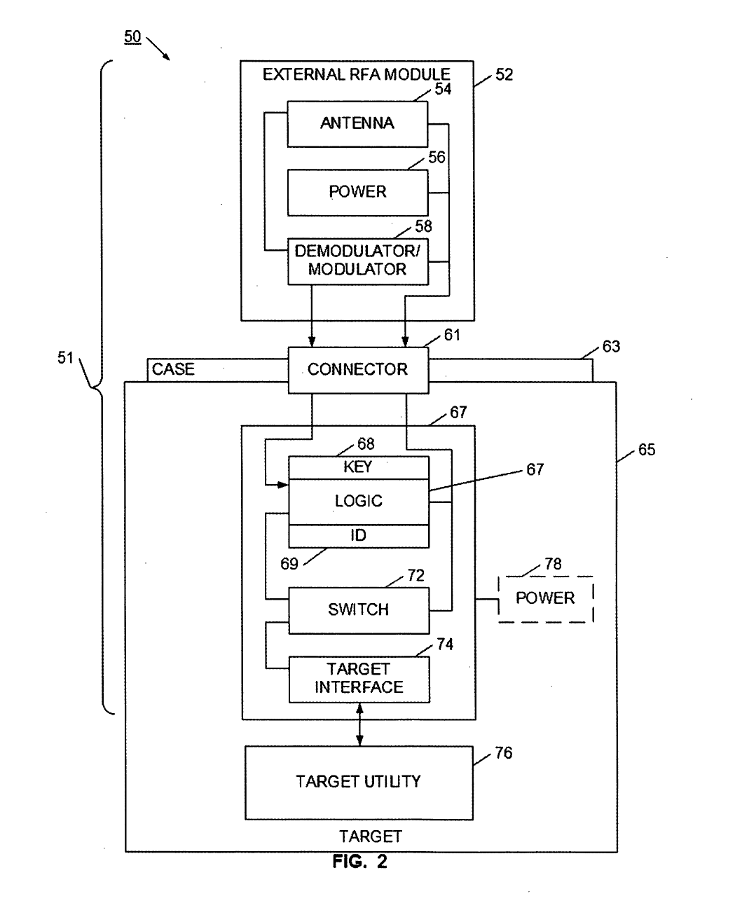

Referring now to FIG. 2, another target 50 for a distribution control system is illustrated. Target 50 is similar to target 10 described with reference to FIG. 1 and therefore will not be discussed in detail. As with target 10, target 50 has a RFA device 51 installed during manufacture, which includes a demodulator/modulator 58 for receiving an authorization code from an external activation device. The demodulator/modulator 58 cooperates with logic 67 to switch the state of the switch 72 between a first state and a second state. Responsive to this change in state, target utility 76 provides a different level of utility for target 50.

The RFA device 51 may have a power source 56 for powering the communication, logic, and switch. In another example, an operational power source 78 in the target may be used to power certain portions of the RFA device. The RFA device may also have a restricted access target key 68, and an accessible target ID 69. The demodulator/modulator 58 may be used to send the target ID value 69 to an activation device. The RFA device 51 has the primary components of the target stored in a housing 65 of the target. In one example, housing 65 is a case or other enclosure. Since housing 65 or other aspects of the target may restrict wireless communication to components within the housing 65, certain circuits and processes for RFA device 51 are on an external antenna member 52, while an internal RFA portion 67 is inside the housing 65. In the example illustrated in FIG. 2, the antenna member 52 has the activation power 56, (which may be in the form of a battery or RF/EM converter), demodulator/modulator 58, and an antenna 54. In this way, the circuitry needing clear access to wireless communications is positioned external to the target housing. Other circuitry for changing utility of the target may be positioned in the internal portion 67. It will be appreciated that other circuitry may be moved from the internal portion 67 to the antenna member 52. For example, the target key and logic may be moved externally in some cases. Also, if activation power 56 includes a battery, that battery may be positioned either within the housing 52 or on the antenna member 52.

The antenna member 52 may be mounted or adhered to the target housing 52, or may be positioned remote from the target and coupled to the target housing 52 through a wired connection. In another example, the antenna member 52 may couple to the target housing 52 through a connector 61 available on the target's case 63. In one example, the target case 63 may have power input ports, on which the antenna member 52 may temporarily mounted. In such a case, the target 50 would be activated with the antenna member 52 coupled to the power plug of the case 63, and after processing at the activation terminal, the antenna member 52 would be removed from the power plug, and the power plug inserted into a wall outlet to place the electronic device in its operable state. It will be appreciated that other available connectors may be used. For example, an existing audio, video, or data connector may be used. However, when using a standard connector 61, it may be desirable to provide an isolation circuit to protect the RFA circuits from loading effects of the target circuits. The target circuits may load the signals at the RFA IC and prevent proper operation. In some cases, the target could actually damage the RFA IC, for instance when a DC or AC connector is used. The isolation circuit may also protect target circuits from possible detrimental effects of signals passed into the target from antenna member 52. By arranging the antenna member 52 external to the target, more robust communication with the activation device may be maintained, as well as more efficient and effective power conversion when converting power from an available RF or EM source.

Generally, the target activation system described with reference to FIGS. 1 and 2 uses a Radio Frequency Activation (RFA) device for selectively activating the target. The RFA device comprises in part a “switch” through which the RFA device is communicatively coupled (data and/or power) to a target. The switch is any mechanism that can be set so that it affects the target's utility (e.g. that prevents the target from functioning properly) and later switched to ‘activate’ the target (e.g. to restore or enable the target's utility). In certain cases the switch may also serve to de-activate, or disable, the operation of a target based on commands or criteria. In certain cases the switch may serve to control access to media, data, information, instructions/commands etc. (collectively referred to herein as “content”) stored in the target. In many embodiments the switch may be logical (e.g. a memory bit) and it may include additional elements/components such as a fuse or electromechanical actuator. RFA devices may comprise different types of “switches” including, but not limited to, logical/data, electronic, electrical, electro-optic (“optical switch or shutter”) and electromechanical: any mechanism that responds to an electrical stimulus and effects a change in the target. An RFA device may also comprise an optical switch consisting in part of an ultraviolet, visible or infrared light output.

Depending on the application, switches may be switched only one time, only a limited number of times, or an unlimited number of times. Further, they may be reversible. The change effected in the target may be temporally offset from the initiation of the RFA switch. For example, an RFA device coupled to an AC powered drill may be ‘activated’ at the retail check-stand (e.g. a switching relay coupled to the RFA device and the drill's power supply is enabled), but the effect of the switch (the drill powers-up) is realized only when the drill is plugged into AC power. The functions of the RFA device including the switch may be combined in different ways and distributed among one or more components/locations in, or coupled, to a target. Further the RFA device may be configured in such a way that some of the functions may be physically decoupled (removed) from the target after the activation has taken place. The antenna, for instance, might be removed. Many of the circuits and processes described herein are applicable to conventional passive and active RFID tags and similar wireless technologies or products.

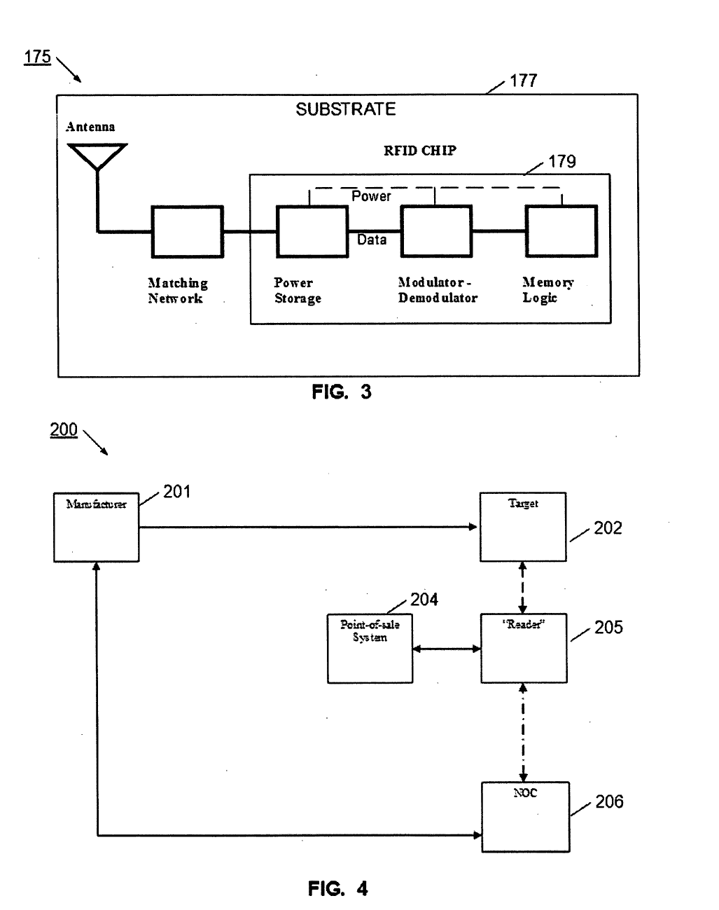

A typical known passive RFID tag 175 is shown in FIG. 3. It consists of an antenna, an impedance matching network, power storage, a modulator/demodulator, memory and logic. The antenna is usually configured on a Mylar® or Kapton® substrate 177 and is connected to a silicon based RFID chip portion 179 through an impedance matching network. The chip receives energy from the antenna through the matching network and stores it within the chip to power the memory and logic functions. A modulator/demodulator allows digital data to be transmitted to, or received from the tag. The memory block typically contains a serial number in a read-only area of memory. Additional memory storage is often provided for storing other data such as product or manufacturing information, distribution, service, or interrogation history, etc. Different types of tags may provide OTP (One Time Programming) or unlimited programming via EEPROM technology. The public identification and other information typically stored in memory are accessible via an external wireless reader.

Unlike the known RFID chip, the RFA device is communicatively coupled to the target (typically via electrical contacts) and it may transmit/receive data, power, or commands with the target. The RFA device also contains logic and typically data, instructions, or commands for conditionally switching the switch based on input received from a device external to the device (e.g. an RF activation device). An RFA device for example, may allow the manufacturer, RFA device manufacturer or a third party to store a hidden or “private key” into write-once memory in addition to the public key and other information. This private key may be randomly generated or it may be based on an algorithm. Further, the RFA device may contain a separate blank area of memory to store a key received from an external source (e.g. an RF activator at the point-of-sale). In this example, logic in the RFA device (pre-programmed instructions or commands) compares the received key to the previously stored private key. If they match (or some other conditional state is realized), the logic will switch the switch (e.g. set a memory bit or blow a fuse). In such a configuration the stored private key would be inaccessible to an RFID reader or any external device. The key, commands, and instructions that define the logical comparison process are typically stored in write-once memory, or permanently configured in hardware or firmware.

In certain embodiments, the logic in the RFA device may be supplemented or combined with additional instructions or commands received from outside the RFA device. There may also be more than one private key stored in memory (also typically write-once memory) within the RFA chip. The logic effectuated may be conditional upon which private key, or combination of private keys, that match the received key. At a minimum the logic consists of instructions or commands embedded in the RFA device, which are sufficient to initiate action upon the realization of a conditional state. In many embodiments the logic is entirely contained within the RFA device.

In some embodiments, the private key (or private keys) stored within the RFA device may enable cryptographic methods to be used to protect data, instructions or commands transmitted to, and received by, the RFA device or the target to which it is coupled. In such embodiments the RFA device may include an encryption or decryption algorithm. An example of an RFA enabled encryption process 200 (FIG. 4) would work as follows: the target manufacturer 201 stores a public key (the ID), a private key and an encryption key in an RFA device coupled to a target 202. The public key is readable by an activation terminal 205 external to the RFA activation device (e.g. an RFID activator linked to a central Network Operations Center (NOC) as illustrated in FIG. 4. The private key and the encryption key are stored in write-once memory and cannot be read or otherwise ascertained from the RFA device by an external device.

The manufacturer 201 encrypts the private key using the encryption key and transmits the encrypted private key paired to the public ID to the NOC 206. When the public key in the target's RFA device is read, for example using an RFID reader at a retail check-stand 204, and transmitted to the NOC, the NOC uses the public ID to lookup the associated encrypted private key. The NOC then transmits the encrypted private key to the RFA device coupled to the target. The RFA device then uses its stored encryption key and stored algorithm to decrypt the private key. The decrypted private key can then be used for comparison to the private key stored in write-once memory in the RFA device. The decryption and comparison process occurs entirely within the RFA device. This approach reduces the risk of a clear-text private key being illicitly obtained from the NOC or during the communication from the target manufacturer to the NOC or from the NOC to the RFA device. Asymmetric encryption schemes using algorithms such as that utilized in the RSA Public Key Encryption scheme and described in the U.S. patent for the RSA algorithm (U.S. Pat. No. 4,405,829, “Cryptographic Communications System And Method”) and now in the public domain, may also be applied using combinations of public and private keys (including those used as encryption keys), and algorithms embedded within the RFA device.

Other encryption schemes may involve an encryption key provided by a 3rd party. For example, a manufacturer may store a retailer specific encryption key in the RFA device coupled to its target and use it, independently or in conjunction with other keys, to encrypt the private key. To decrypt the private key received from the NOC, the algorithm in the RFA device needs the 3rd party key (e.g. input at the check-stand independent of the NOC). In another embodiment a 3rd party key may be stored by the RFA device manufacturer and be unknown to the target manufacturer. The 3rd party encryption key may then be sent to NOC or via an alternative path to the reader and on to the RFA device. Encryption systems such as those described above can be used to secure the conditional logic process effectuated within the RFA device (e.g. to prevent unauthorized switching of the embedded switch). They may also be used to secure the transmission to, and usage within, an RFA device of data, instructions or commands. Further, such encryption systems can be used to enable different parties independently or in combination to effectuate control over the conditional logic and the dependent outcome (switching the RFA Switch).

It is important to note the difference between the RFA device and some RFID tags such as EPC generation 2.0 devices, which can utilize passwords for the purpose of controlling access to information (data) stored in the memory of the RFID tags. These passwords control the ability to read the information stored in the memory, and also the ability to write new information, or change existing information that is already stored. In these cases, the only thing being accessed or changed is the data itself. Even the password can be changed by writing a new password to the location in memory where the password is stored. Further, these password schemes only affect the ability to read and write data via the RF communication path to the external RFID reader, and do not interact with the target or the target's utility. The RFA device works in a fundamentally different way. The private key(s) is stored in memory within the RFA device at the time of programming by the manufacturer of the target device, the manufacturer of the RFA device or a 3rd party. These private key(s) are typically stored in write-once memory and cannot be read back by the RF reader (or any device external to the RFA device) nor preferably can they be changed in the future by any means. Once a private key(s) is programmed into an RFA device, prior knowledge of it is required to supply the correct key(s) that meet the conditions necessary for the RFA switch to be switched.

In certain embodiments involving more than one private key, one of the private keys, the primary private key, may configure the logic within the RFA device to combine the secondary private keys stored in memory to result in an computed key that can be compared to the received key sent to the RFA device from the external reader at the time of activation. If the computed key matches the received key then the RFA device enables an output (and optionally an input that affects the target's utility. This output is a typically via a physical connection (e.g. an electrical contact or pin) that can logically function in a number of different ways (e.g. a state change or a defined data sequence) depending upon RFA device logic configuration information supplied to the RFA device by the target. This logical data sequence can be a function of the primary key, and other configurable logical means within the RFA device. In another example, the logical sequence uses an externally generated data stream, such as a data stream provide to the RFA device from the target circuitry, such as from a microprocessor. The logical configuration information can be sent to the RFA device via a number of techniques such as a serial link to the enable pin of the RFA device, or by a pair of dedicated mode pins on the RFA device. The configuration means is primarily controlled by the target, but could also be a function of commands stored within the RFA device or sent to the RFA device from the reader after completion of the activation comparison process.

It may be desirable to deactivate a target, for example in the situation where a target is returned to a retail outlet after having been purchased and activated. One preferred method of reactivating a target is to send a command to the RFA device that causes the output line (pin) to be deactivated. If the target is to be reactivated, it may be desirable to generate a computed key that is used for comparing a received key that is different from the previously received key (for matching to the computed private key) and to effectuate the conditional logic. An example of a way to securely affect such a system is to use a counter within the RFA device that keeps track of the number of times that the RFA device has been deactivated. The RFA device internally generates a new computed key automatically through its logic by using the primary key and the state of the deactivation counter. This process can be taken further by logically combining the secondary keys in a different sequence. The private keys are not changed. The sequence is known to the manufacturer (or the party that originally stored the key in the RFA device), and is tied to the public key (e.g. ID, serial number) of the RFA device. The reader has access to the deactivate counter state, and sends that data along with the RFA device's public key back to the NOC in order to receive the correct (sequential) key. The reader cannot change the key and/or key sequence directly by writing data to the RFA device. The RFA device itself changes the key or key sequence by using the mode configuration information in addition to its own internal logic.

To prevent attempts to defeat the security scheme effectuated within the RFA device by repeated transmission of keys to the RFA device, there are several alternative techniques that can be employed. One is to limit the number of false key submissions, and particularly the number of false key submissions over a period of time. Logic and programmable memory within the RFA device could automatically shut down, temporarily or permanently, the internal authorization process after a specified number of false comparisons. Another solution would be for the logic, using an internal clock, to limit the rate at which the RFA devices receives or processes digital keys or compares them to the private keys. Alternatively, the speed of the RFA device (e.g. clock speed) could be limited to achieve a similar outcome.

A denial-of-benefit security system depends on everyone involved with the product including would be thieves, employees and consumers to be aware that the target's utility is compromised and it must be activated before its value is restored. A successful denial-of-benefit security system therefore depends on a means for generating awareness of the target's participation in the security scheme in addition to the mechanism internal to the target that alters its utility (the switch). One cost effective solution is to couple an RFA device with a visible “symbol”, mark, icon or message on the outside of the target or its associated package that identifies the target as a participant in the system. Further, the symbol can be positioned on a target's package relative to the RFA device's antenna (which is coupled to the target within) to facilitate placement of an external reader.

In certain embodiments the RFA device, independently or in conjunction with elements within the target, may employ means for determining the status of the switch or target (e.g. did the RFA switch, switch, as intended; is the target active, what features were enabled or disabled), and communicating such information to an external device such as an RFID reader coupled to a point-of-sale system. Depending on the specific embodiment, the means may include logic or circuitry to measure or test elements of the RFA device or the target to which it is coupled. For example, when a ‘successful’ comparison is made of a received key and a private key, a value can be written to a memory that is externally accessible to an external device. In another example, the electrical properties (e.g. resistance, capacitance etc.) of circuitry or materials in elements of the RFA switch in the target can be measured, when the target is powered, and the results output to an external device. An example of communicating the state of the RFA device would be to set an indicator state for a directly coupled element such as an LED. Another example would be the removable antenna element of an RFA device (described herein) combined with an electro-chromic film that changes appearance depending on the state of the RFA device (e.g. red prior to activation, green after).

In embodiments where the status information is output to a communicatively coupled external device (e.g. an RFID reader) the information can be used locally or transmitted to a remote location like the NOC or to the manufacturer or a 3rd party. The information can be used to execute dependent actions such as retry an activation if the initial attempt failed. The information can also be used to determine the state of a target (active or inactive) or whether it's been activated before. The information can also be used aggregated (e.g. at the NOC) to identify, diagnose and report problems. It may also be used to identify unauthorized attempts to breach the system. The status of an RFA device can also be used as a dependent variable for a variety of transaction systems. For example, a customer cannot be charged until the target is activated. Alternatively, a target cannot be activated until the customer is charged, has evidenced an ability to pay (e.g. a test to see if a credit card or customer account is valid), or payment is made. The status of an RFA device can also be used in conjunction with other security schemes. For example, in a retail store, a product that had not been successfully activated at the check-stand could be detected by an RF sensing system located at the exit doors and an alarm triggered.

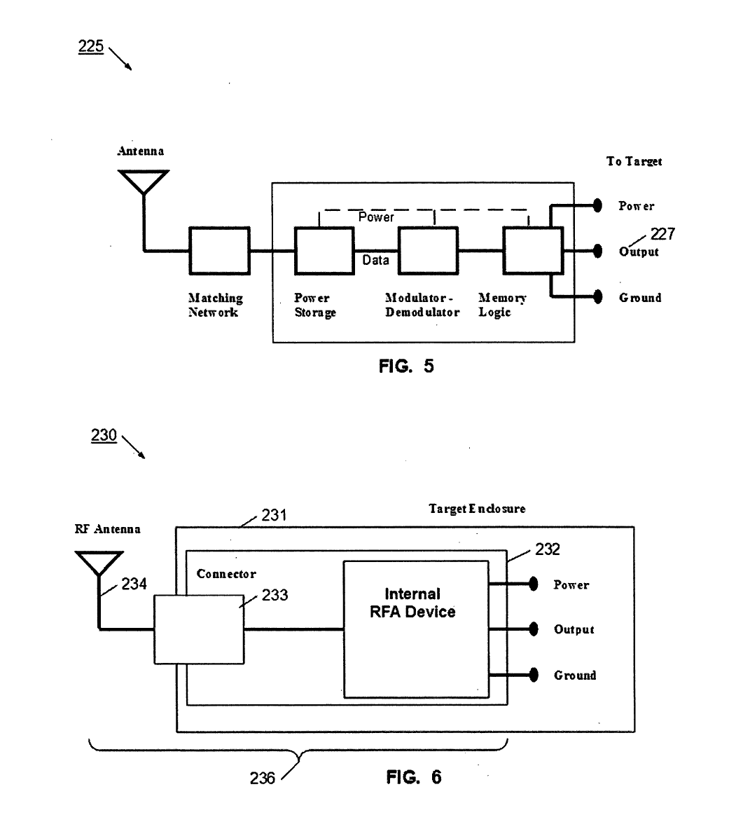

FIG. 5 illustrates one configuration of an RFA device 225. In this configuration the switch 227 consists of a memory bit that can be switched “True”, setting a logic state at the “Output”, that can be read by the microprocessor in the target and affect its utility. Alternately, the output switch line 227 (associated with the output bit) could be used to pull down the reset line of the microprocessor, microcontroller, or any other logic line of the target circuitry, that would cause the target to not function when turned on. Only if the codes matched, would the line be allowed to go “true” by the RFA device, and the target to function normally. It will be appreciated that “true” may be represented in some circuits as a “high” value, and in other circuits as a “low” value.

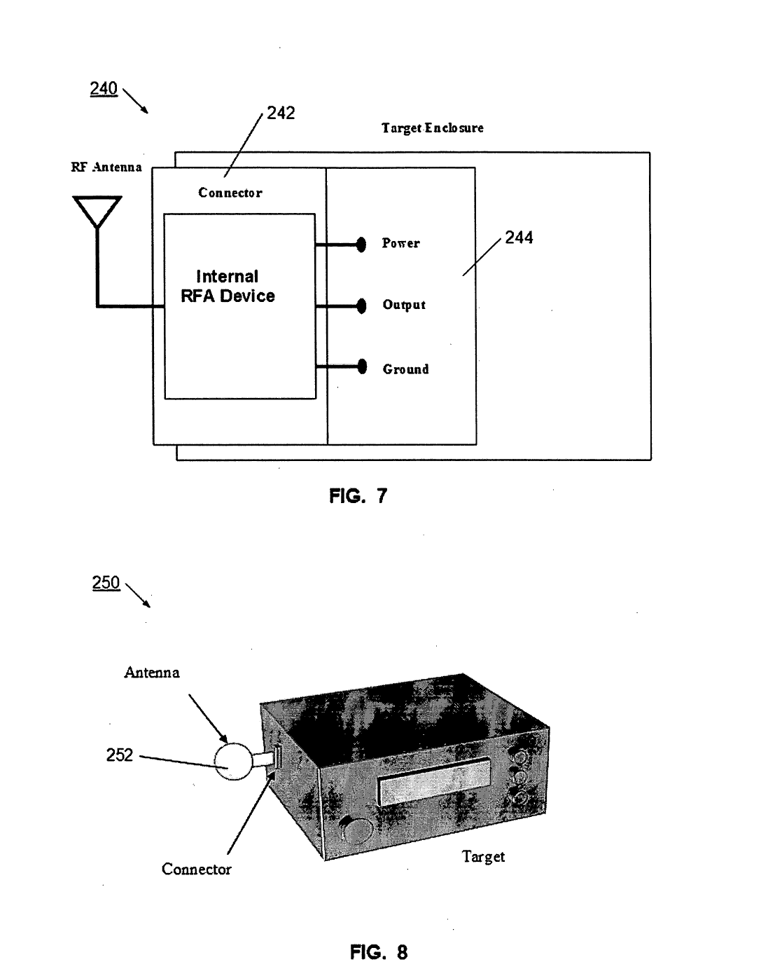

Referring now to FIG. 6, many commercial products have either a metal shield, or a metal case, which will not allow efficient RF coupling from the reader to an internally installed internal RFA device. For these types of targets, it may be desirable to place the antenna 234 outside the metal enclosure 231. The internal RFA device 236 however, could be mounted on the printed circuit board 232 (PCB) of the target and some type of connector 233 would connect the two. This leads to the configuration generally shown in FIG. 6. The construction shown in FIG. 6 allows the RF antenna 234 to couple through the metal enclosure 231 of the target via the PCB mounted connector 233. The internal RFA device would also be placed on the PCB 232 of the target. It is desirable for the connector to pass RF signals at one of the 3 primary frequency bands in use today for RFID tags: 13.56 MHz, 900 MHz, or 2.4 GHz, but may require additional circuitry to adequately pass RF signals. In the alternative, a higher quality connector capable of more readily passing RF signals may be used. It is desirable to use an in-expensive connector such as a zero insertion force flat flexible cable (ZIF FFC) or a smart card connector for this interconnect. It may also be desirable for the matching network to be on the antenna side of the connector. This implementation allows the antenna to be disconnected from the target after it has been activated. Another similar configuration 240 is to integrate the RFA device into a custom connector 242 so that only a single device needs to be installed on the PCB 244 of the target, as shown in FIG. 7.

As described with reference to FIGS. 6 and 7, the connector allows the antenna to be placed outside of the target's enclosure. As shown in FIG. 8, a target device 250 has an antenna 252 attached to the target's connector. The antenna is electrically coupled to an internal RFA device, which enables efficient RF communication and power conversion. Also, the antenna member 252 would be removable after activation. The antenna 252 may have a mating adaptor that causes the antenna 252 to be oriented in a particular direction. For example, the antenna may be oriented perpendicular to the enclosure so that the RF energy can couple to it in a more effective way. A stiff substrate may be used for the antenna so that it will be self supporting and can maintain a particular orientation such as that shown in FIG. 8. It is important to note the ability to orient the antenna so that it does not lie up against the metal enclosure. This prevents the metal enclosure from loading the antenna and changing its impedance, and ultimately it's coupling efficiency to the reader. As shown in FIG. 8, the antenna will couple better with a reader located in front of, or behind the target. If the connector and antenna is rotated 90 degrees, then the antenna would couple the best from the top or the bottom of the target. The connector can be located almost anywhere on the target's PCB. It is desirable to mount it near a corner of the target if possible to minimize RF coupling issues. The antenna may be configured as part of the target's packaging or shipping container.

Referring to FIG. 8, a controlled electronic target device 250 is illustrated. Electronic device 250 is an electronic device having a case for enclosing and protecting the utility means and other operational circuitry and devices. In one example, the case is metallic, and therefore restricts wireless communication to components and circuitry within the target. In this way wireless communication to devices and components inside the target would require an unduly strong RF or EM signal to robustly and effectively communicate. To improve the effectiveness of wireless communication, an antenna member 252 is installed external to the case, and electrically coupled to an internal RFA device within the housing. In this way, the antenna 252 may be readily accessible for wireless communication with an activating device, while still maintaining the switch for the RFA device within the target housing. In a particular example, a connector is positioned on the housing. This connector may be a connector specifically designed for antenna 252, or may be an existing connector for the target. For example, if the target is an audio device, the target is likely to have several existing audio connectors. In another example, target 250 may be powered through an AC or DC external power connector. In this way, the connector may be a power plug or adapter input. It will be appreciated that other types of connectors, such as Ethernet data ports, serial data ports, USB connections, and other standard audio, video, and data connector types may be used.

In use, antenna 252 is attached to connector during the manufacture or the shipping process. At the point-of-sale environment, an activating device cooperates with the antenna 252 to send and receive information and power to and from the RFA internal device, which is inside the target enclosure. In particular, the antenna may receive a request for an identification value and transmit an identification value to the internal RFA device. The activation device, after performing its authorization routines, may then send an authorization key through the antenna 445 into the internal RFA device. The internal RFA device has logic coupled to the antenna through the connector which determines that it may change its switch to another state. After the state of utility has been changed, the internal RFA device may report the verification of the change through the antenna 252 back to the activation device. Typically, at this point a consumer will transport the electronic device 250 to another location, and place the electronic device in an operable state. The consumer may remove the antenna member 252 and dispose of it. In another example, antenna member 252 is integrally formed with the case and may remain on the case.

In some cases it may be advantageous to utilize devices contained within the target to effect communication with the internal RFA device, for example when the target is a “wireless” device such as a wireless access point, where its antenna and circuitry may be designed to accommodate such communication. Many targets utilize foam inserts to isolate the target from shipping damage. The antenna could be easily integrated into those inserts. Using effective antenna design practices, the packaging foam could serve as a “spacer” between the antenna element and the metal case of a target, and assist in maintaining the efficiency and operation of the antenna, thus facilitating the communications between reader and internal RFA device. The antenna substrate material could be any relatively stiff material that has the required dielectric properties for the antenna to function properly. Traditionally Mylar® or Kapton® have been used, but a variety of materials including stiff cardboard, or coated paper may also be used.

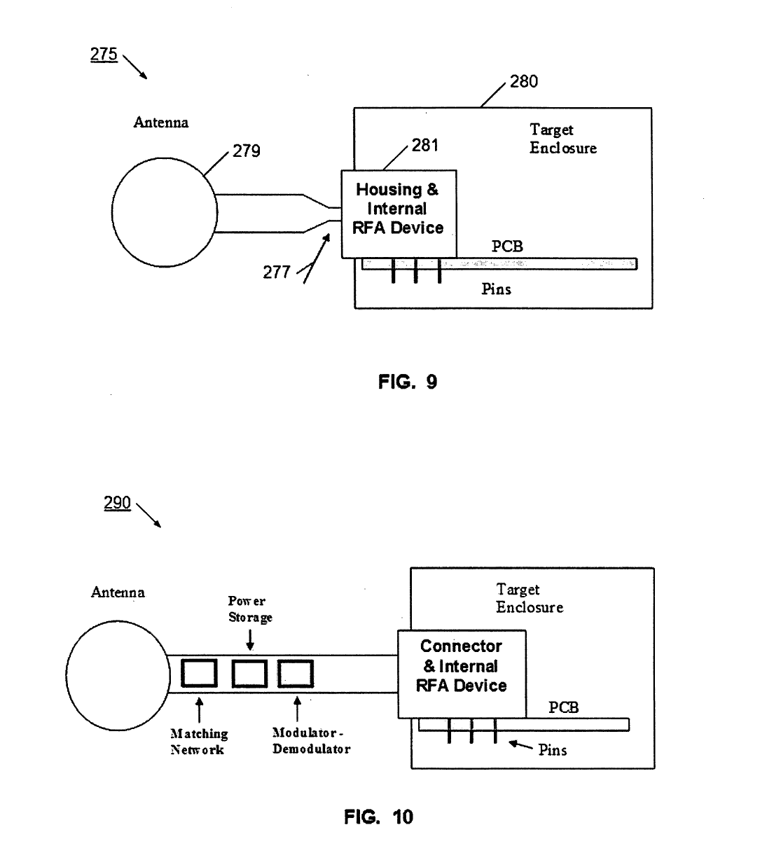

An alternative is to configure the antenna and connector as a “break away” system 275 as shown in FIG. 9. For example a Mylar® substrate can be designed so that it sheers in a necked down area 277 along its length. A molded plastic part 281 can be used to bring the antenna 279 outside of the enclosure 280. It would also facilitate attachment of the internal RFA device to the target's PCB. In FIG. 9, the target enclosure 280 encloses a printed circuit board on which the internal RFA device 281 is positioned. An antenna member 279 is coupled to the internal RFA device 281 through a connector that is formed integrally with the internal RFA device. In this way, while internal RFA device 281 is shielded from RF and EM communications, antenna 279 is externally positioned for ready communication. Although antenna member 279 is shown having only the antenna structure external to the target enclosure, it will be appreciated that other parts of the internal circuitry may be moved external. For example, a power source in the form of an RF/EM converter may be provided on the antenna member 279, as well as a battery. In another example, some or all of the logic may be moved to the antenna member, as well as the restricted access storage for a target key. Of course, this latter configuration may be less secure, but may be useful to some applications. Typically however the switch and logic for the RFA device will remain within the target enclosure due to its coupling to utility means, which are within the target enclosure.

At 900 MHz and at 2.4 GHz, the connector becomes important in terms of its electrical characteristics and requirements. Referring to FIG. 10, As an alternative 290, rather than passing RF through the connector, the power storage and modulator/demodulator functions, can be moved to the antenna side of the connector. The output of the modulator/demodulator is a pulse train of a much lower frequency riding on a DC level. This signal is not nearly as critical in terms of its connector requirements. The components that must move to the antenna side are small and inexpensive, and can be discarded along with the antenna. This allows connectors such as the smart card interface, or the ZIF FFC type to be used at all RF frequencies. A major advantage of these connectors is that they use only exposed contacts on the antenna substrate for the connection. In this configuration an electromechanical connector on the antenna is not necessary. This drastically reduces cost and complexity for the antenna. A further advantage is that the matching network is now contained only on the antenna and is not affected by the connector, or internal RFA device that the manufacturer will integrate into the target. Alternatively, the entire RFA device may also be incorporated as part of the disposable element.

In one arrangement, the internal RFA device is integrated into the connector which mounts to the internal PCB of the target. This means that the manufacturer only has to place a single part on their internal board, and place a corresponding hole in their enclosure for the antenna connection. The connector and RFA assembly can utilize thru hole or SMT leads, and may also include mechanical locating mechanisms, or mechanical attachment mechanisms.

It is also possible to utilize an existing connector on some targets rather than adding a separate connector. For instance, on many commercial audio and video products, the low level audio input can be utilized. Most of these products use an RCA phono jack for the audio input connector. The antenna shown in FIG. 10 above can have an adaptor that is constructed to be terminated in a RCA phono plug, and would be plugged into the phono jack. Once the target was activated, the antenna and phono plug would be discarded. The audio input on the target would now function only as an audio input. FIG. 10 shows another example of the antenna member. In this example, the housing has a printed circuit board holding an internal RFA device, which is integrally formed with a connector piece. This arrangement is particularly useful when using an existing audio, video, data, or power connector on the target. For example, it may be desirable to use an audio connector to connect the external antenna member. However, the internal audio circuitry is typically constructed to operate at relatively low frequencies, for example less than 100 kHz, and in some cases may be designed to operate at less than 30 kHz. Accordingly, the otherwise desirable 900 megahertz or other radiofrequency signal received by the external antenna may not be robustly or effectively communicated into the internal RFA device when at a radio frequency. Accordingly, the radio frequency signal is demodulated to a lower frequency using the modulator-demodulator, which is mounted on the antenna member. For example, the antenna may receive a 900 MHz RF communication, and demodulate that signal into the lower frequency signal capable of being transmitted through the audio level connector. In this way, a relatively low-frequency signal may be received by the internal RFA device, and used to change the state of the its switch.

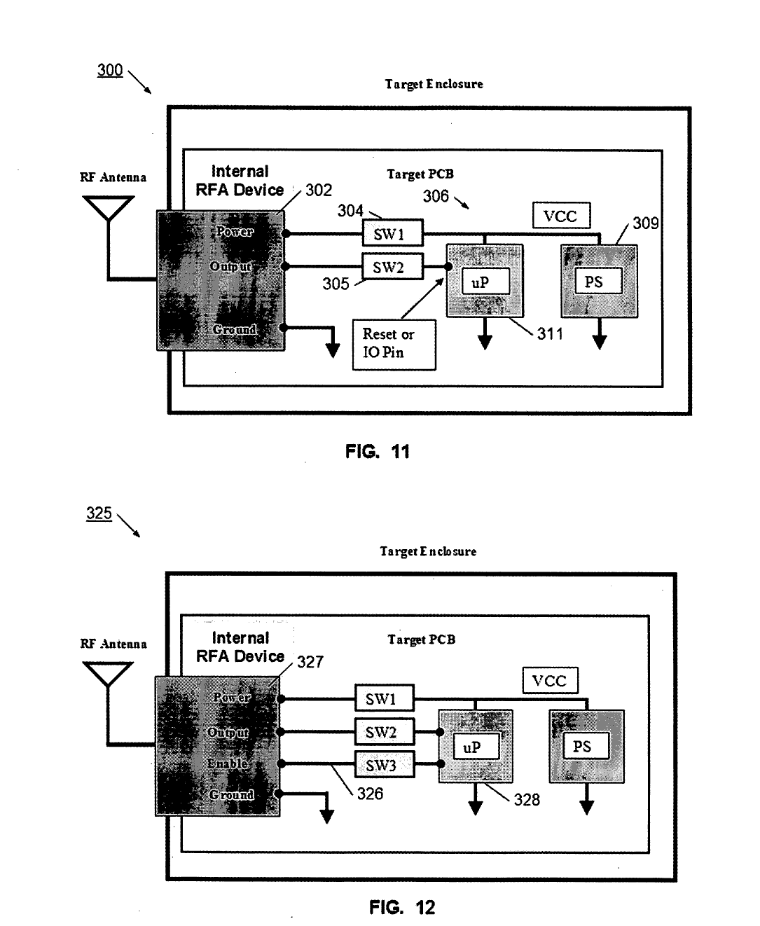

There are several methods by which the RFA device can communicate and interface to the target. Typically, and in particular in embodiments where the RFA device interfaces with circuitry in the target, there is a system provided to isolate the RFA device from the target during RF communication with the reader. During activation, the RFA device is powered by the RF energy from the reader. The target however, is not powered, and is prevented from drawing energy from the RFA device during this time. Once the target 300 is activated and powered, it provides any needed power to the RFA device, and interfaces with the output line as shown in FIG. 11. In FIG. 11 power or output signal isolation is achieved by adding 2 switches, SW1 (304), and SW2 (305) between the internal RFA device 302, and the target circuitry 306. The target circuitry 306 which interfaces to the internal RFA device will typically consist of a power supply 309 (PS), and a microprocessor (uP) 311. Since both the PS 309 output (VCC) and the input to uP 311 will be low during RF activation, both SW1 and SW2 are opened during RF activation. SW1 and SW2 can be implemented by a number of means including, but not limited too: diodes, bipolar devices, FETS, CMOS switches, etc. SW1 and SW2 can be controlled either by the target power supply 309, or other target circuits. When the target is powered on, SW1 is turned on supplying power to the internal RFA device. A short time later SW2 is turned on which allows communication between the internal RFA device and the target uP or other circuits. In some targets, a uP may not be used, but the target can still be activated by using RFA Output to enable or disable its circuitry by any means that the manufacturer deems appropriate. VCC can be any voltage but will typically be: +3.3V, or +5V.

To increase tamper proofing of the target, the internal RFA device 327 can utilize an “Enable” line 326 as shown in FIG. 12. SW3 serves to isolate this line 326 in a manner similar to SW2 which was previously described. The Enable line 326 is an input to the internal RFA device from the target 325 microprocessor (uP), microcontroller 328, or other circuitry. It can be a state change, or a serial data stream. The internal RFA device can utilize this data stream along with its private key to output another serial data stream to the target microprocessor (uP), microcontroller, or other circuitry. This allows any number of encryption algorithms to be utilized which are tied to a private key known only to the manufacturer. Since the incoming data stream from the target can be varied, the output data stream will change depending upon the encryption algorithm in a way only known to the manufacturer. It is also possible to integrate a low power microprocessor, microcontroller, or custom circuitry along with the internal RFA device function on a single silicon substrate. This provides a high level of tamper-proof protection if a OTP microprocessor, microcontroller, or custom circuitry with on-board EPROM is utilized. The microprocessor, microcontroller, or custom circuitry could securely communicate with the main system processor via an SPI, or I2C serial data link.

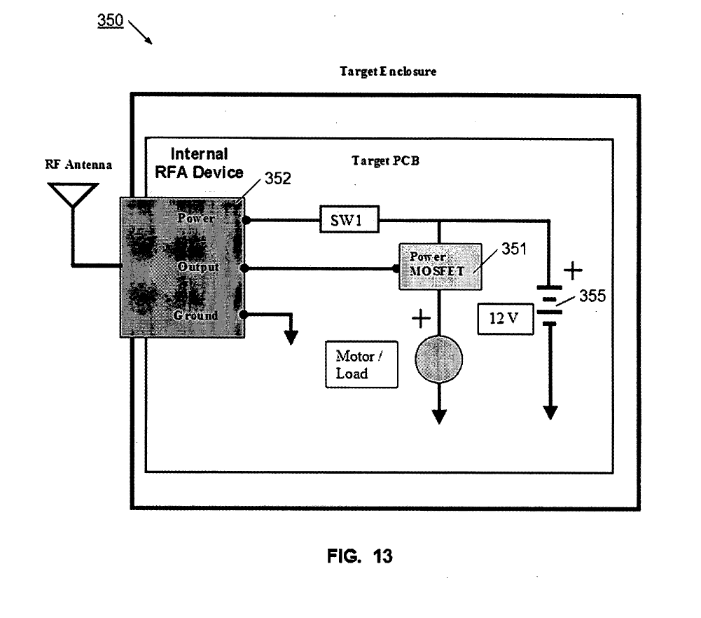

The internal RFA device can also be utilized to activate targets that do not have microprocessors. For example, if the target 350 has a DC supply 355 such as a cordless drill, the internal RFA device 352 can be used to turn on a power MOSFET 351 in series with load as shown in FIG. 13. The power MOSFET 351 can be utilized in a way to eliminate the need for SW2. The gate of the FET 351 will not load the internal RFA device during RF activation. In this embodiment SW1 is activated by the trigger switch of the cordless drill. The manufacturer may choose to encapsulate all of the circuitry for additional tamper proofing. For AC powered devices, the power MOSFET could be replaced by a solid state switch. A simple AC/DC converter could be used to power the RFA chip.

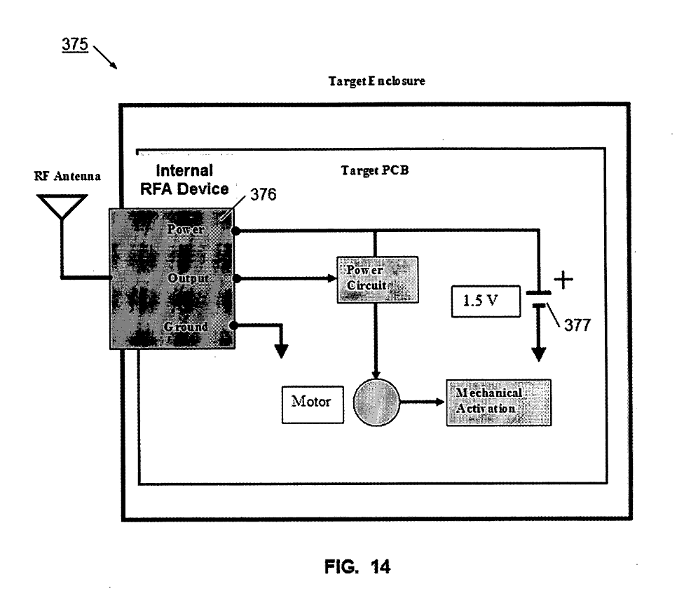

Referring now to FIG. 14, another RFA activated target 375 is shown. Target 375 has an internal RFA device 376 that also is coupled to a battery 377 in order to increase versatility. Previously discussed internal RFA devices may also use this approach. An on-board battery 377 allows the internal RFA device to be “active”. Thus, the internal RFA device and its functions can be powered by the battery 377. It no longer requires externally received RF energy to power it. One benefit of this approach is the increased frequency range that the internal RFA device would function over. An RF amplifier can be built on the front of the internal RFA device to improve receive sensitivity, and a RF power amplifier can also be built for transmission back to the reader. Since the internal RFA device circuits are typically already CMOS or other low power technology, they draw very little current from the battery prior to activation. Thus, the shelf life prior to activation can be quite long. Some versatility comes from using the battery to power additional circuits and/or functions that can be added that may not be practical to power by RF energy. For instance, FIG. 14 shows an internal RFA device 376 that is powered by a small 1.5V battery 377. Any battery technology can be utilized, but a small primary battery would be preferred. The battery provides power to the internal RFA device as well as to the a power circuit. In operation, the power circuit would be in sleep mode until activation occurs. When the internal RFA device output becomes active, the power circuit wakes up and provides its higher power function. This function draws its energy from the 1.5V battery rather than from RF-generated power, so is able to perform a wider range of electrical functions. In FIG. 14, the power circuit provides power to a motor or solenoid to provide mechanical motion. This mechanical motion could provide mechanical activation of the target by either locking or unlocking a mechanical function of the target in order to allow functionality.

Many other functions and behaviors can be implemented using this approach. Audible, ultrasonic, optical, thermal, and any other function that require power can be utilized. This allows not only activation of the target by various means, but also can provide an indication back to the check-out clerk, or customer that the product has indeed been activated. For instance, the battery can provide energy to a LED indicator that is visible through a clear window in the target packaging. When successful activation has been achieved, the LED can be turned on (100% or blinking), to indicate activation. An alternate approach is to supply the LED as a stick-on label with a printed antenna that is applied to the outside of the target's package. When successful activation occurs, the battery and power circuit turn on a small transmitter. The transmitted signal picked up by the printed antenna on the label and causes the LED to light. Further, the antenna coupled to the internal RFA device may be constructed out of the same material/process used to construct the energy storage element (e.g. a thin-film battery) or some other element of the target (e.g. the materials comprising a reflective layer of an optical disc).

In addition to the electrical/electronic targets described above, the RFA devices described herein may be applied to a wide variety of non electrical/electronic targets for example:
a. An optical disc with an embedded RFA device comprising an electro-optic film that acts as an optical shutter (‘opens’ and ‘closes’) that allows or disallows an interrogating laser light from reading the data structures contained within the disc.
b. A media such as a document, passport, ticket, credit/debit or stored value card, optical disc with an embedded RFA device comprising electro-optic material that cover or reveal underlying content upon activation.
c. A perfume bottle with an RFA device comprising electro-chromic materials embedded in the glass that produce an unattractive appearance or message until the RFA tag is activated.
d. A watch with an RFA device comprising an electromechanical actuator that prevents/enables the watch's movements from working.
e. A battery with an RFA device comprising electro-chemical material incorporated into a charge indicator.

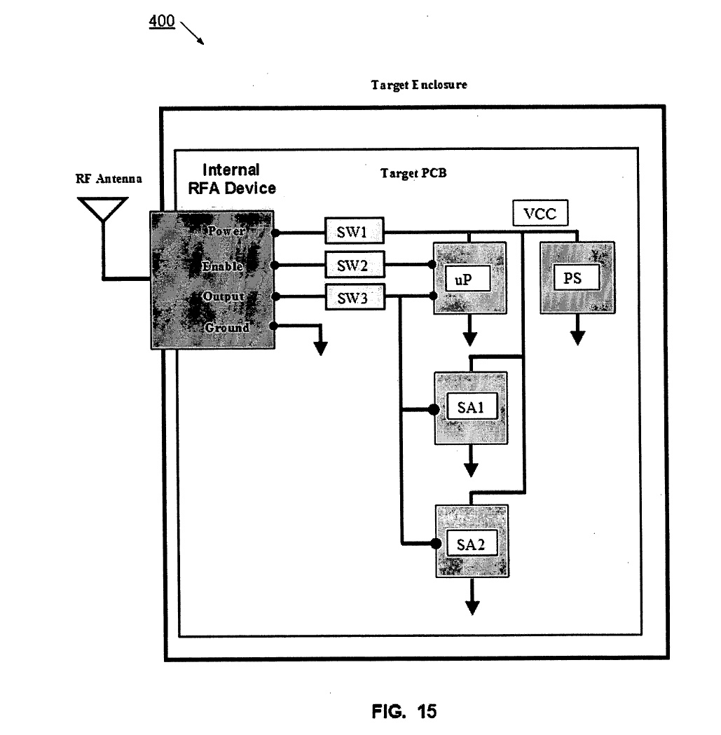

In some situations it is desirable to mass produce a target (e.g. a computer), package it for shipment and then activate individual options (e.g. preloaded software or content, or hardware features) or enter preferences (e.g. user or retailer name, configuration information etc.) at either the manufacturing facility or the retail point-of-sale. An RFA device configured to receive and output multiple data elements such as passwords or keys to decrypt preloaded software can be used for this purpose. For some classes of targets it is desirable to activate multiple sub-assemblies within a single target to deter theft of the target for its parts. An example is a laptop computer which contains multiple valuable sub-assemblies such as a hard disk drive, LCD display, CPU, CD disk drive, etc. In one example each subassembly may have its own internal RFA device and is activated by an activation signal to each assembly. Another example 400 of how multiple sub-assemblies can be individually activated is shown in FIG. 15.

Referring to FIG. 15, the operation of the switches SW1, SW2, and SW3, and the other blocks except for SA1, and SA2, are similar in operation to the system shown in FIG. 12. Because it is desired to disable the uP, and sub-assemblies SA1, and SA2 unless activation of the target occurs, there are some important differences, however. When activation occurs, the internal RFA device remembers that it has been activated. When the target (e.g. a laptop computer) is powered up or boot power is applied to the uP, SA1, SA2, and the internal RFA device. Since the target's manufacturer knows what the private key is for the particular internal RFA device used in the target, that information can be placed in the boot code section of the uP. When the processor boots, it sends a data sequence to the internal RFA device enable line, and receives a modified data stream back on the internal RFA device output line. If the output data stream does not match what the boot code expects to see, the uP will not function. Thus, removing the uP without have the internal RFA device and the activation code renders the uP useless. Once the uP boots, it sends data to the enable line of the internal RFA device instructing the internal RFA device to send data out to the sub-assemblies SA1, and SA2 telling them to activate. A custom chip in SA1, and SA2 compares the data from the RFA chip, to data from the uP. If they do not match, sub-assemblies SA1 and SA2 will not function. This custom chip, in the sub-assemblies, would have custom data encoding of its own built in, that the manufacturer knows about, and that the uP would also know. Without knowing what this encoding is, and without the private key, the sub-assembly will not function. The custom data encoding in the sub-assembly chip prevents supplying the same data to the IC inputs and making the sub-assembly function.

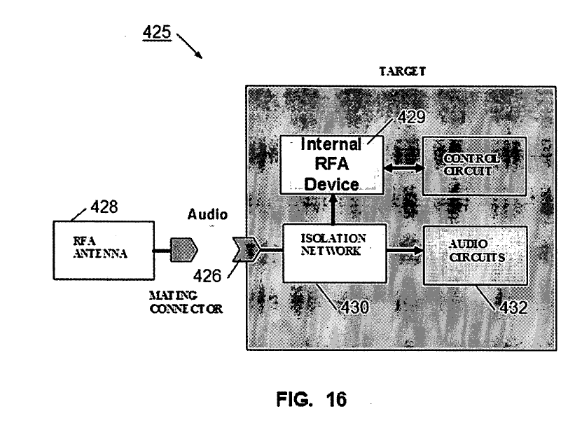

In many instances it may be desirable for the manufacturer to utilize an existing connector on the target device to couple in the RFA signals from the RFA Antenna member to the internal RFA device in the target. Examples of existing connectors on common targets include the AC Power Mains, Audio, Video, DC Power, as well as many others, all of which may be used to couple in the RFA signals for target activation. One arrangement is shown in FIG. 16 using a target's 425 audio input connector 426 to couple an RFA antenna member 428 to the internal RFA device 429 as an example. The target 425 in FIG. 16 includes a frequency selective isolation network added to the target between the connector (audio input) and the target circuitry (audio circuits), associated with that connector. The RFA antenna member has the mating connector (plug) attached to it which plugs into the connector (jack) on the target. This connector type may change depending upon the function of the connector on the target (e.g. a power supply connector may be different than the audio input connector). The isolation network isolates the audio circuits from the RFA antenna member and the internal RFA device. When RF signals are present during the activation process, the RFA signals are passed to the internal RFA device. The target circuits associated with that connector (audio) are isolated from the RFA signal path, and do not affect the RFA signals. Once activation is complete, the RFA antenna may be removed and the target is connected to an audio source by plugging in the audio cable coming from the audio source. In this mode, the isolation network 430 passes the audio signal to the audio circuits 432, and isolates the RFA circuits from the normal functionality of the connector and associated circuits. This general method can be applied to specific embodiments as shown in the following figures and examples.

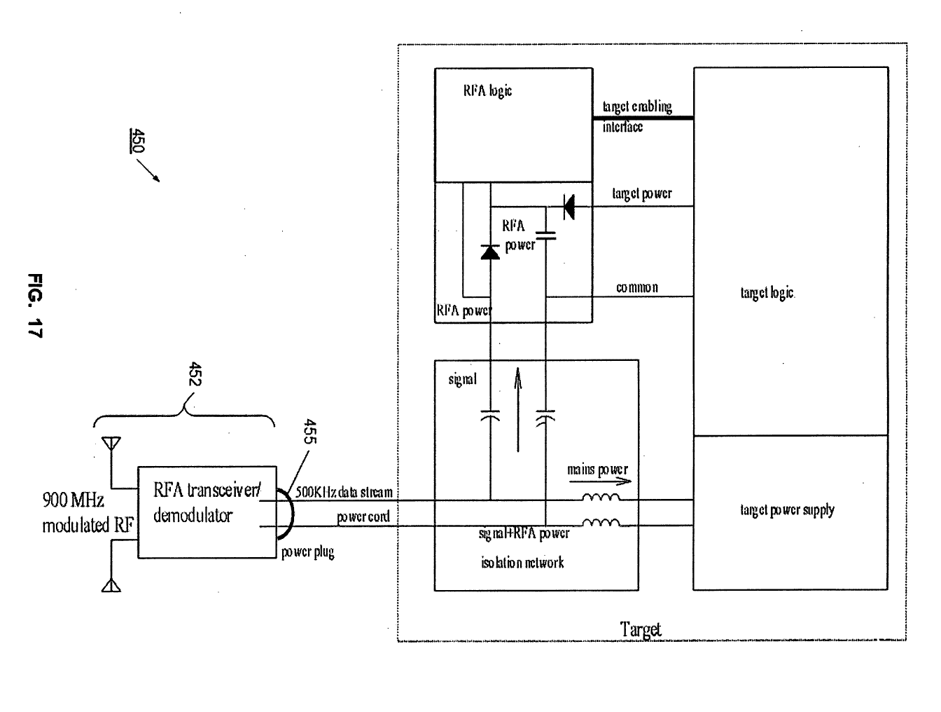

FIG. 17 illustrates an electronic device 450 with an external antenna member 452 coupled to an AC connector or power cord 455. It plugs unto the prongs of the pendent AC power cord 455. With an appropriate physical connector the same design could be used for an IEC power entry connector. In this embodiment, the transceiver/demodulator converts the incoming modulated RF (e.g., 900 MHz) signal into a lower frequency (e.g. ˜500 KHz) demodulated data stream using appropriate digital encoding techniques. This low frequency (˜500 KHz) demodulated signal is coupled to the power cord connector on the target. The isolation network which separates the activation data stream from the target power input module, is connected between the AC power connector, and the target power supply. It consists of 2 inductors and 2 capacitors. These components are selected based on the frequency ratio between the signal frequency used by the target connector, (in this example 60 Hz), and the activation frequency being used, (˜500 KHz). At 500 KHz, the inductors present a high impedance to the activation signals, while the capacitors present a low impedance. Thus, the activation signals couple to the activation circuitry, and the low power supply impedance is isolated by the inductors. When the target is powered by 60 Hz, this situation reverses. The inductors look like a low impedance and couple the 60 Hz energy to the supply, while the capacitors look like a high impedance to the 60 Hz energy, and prevents the 60 Hz from coupling into the activation circuitry.

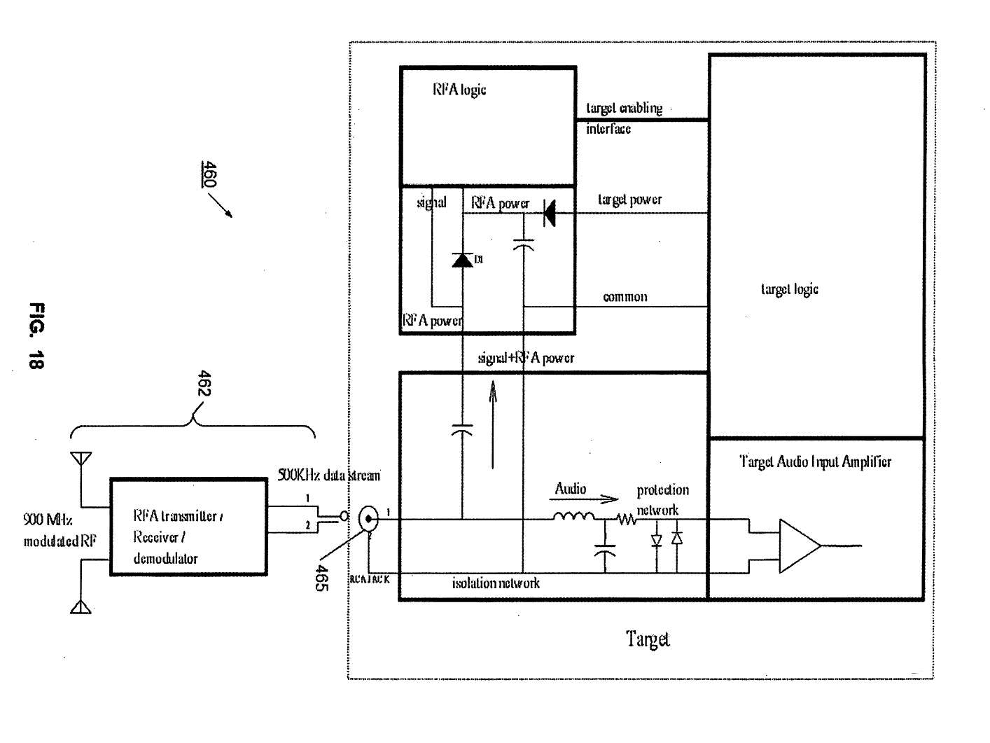

FIG. 18 illustrates an electronic device 460 with an external antenna member 462 coupled to an audio input port 465. Audio signals require bandwidths as high as 20 KHz, which means that the ratio of the activation signals to the audio signals is less than for the previous 60 Hz power example. This lower ratio may require a more complex filter topology in order to achieve the required isolation of the signals. In this example a shunt capacitor in addition to the inductor has been added in the audio path. This results in a filter with more attenuation (sharper cutoff characteristic) for the activation signals. Since the audio input can be low level, additional components may be added to prevent damage to the audio input stages. A simple dual diode clamp with an appropriately sized resistor can accomplish this. When the target is powered in the normal operational state, the activation power diode D1 is reverse biased by the target power, and thus presents a high impedance to the audio signal. This isolates the activation circuitry from the audio signal, as well as isolating the audio circuitry from any noise sources in the activation circuitry.

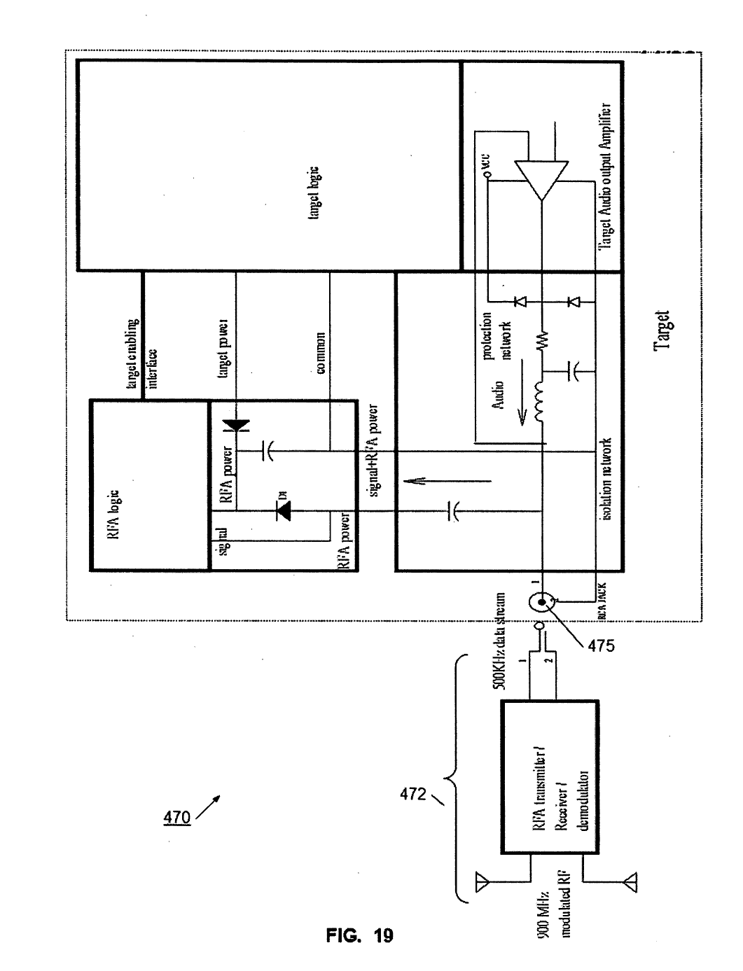

FIG. 19 illustrates an electronic device 470 with an external antenna member 472 coupled to an audio output port 475. As described in FIG. 17, the filter topology may be more complex at audio frequencies. In this case since the connector is an audio output, a different topology is required to protect the audio output circuits from overload. Although a simple 2 pole LC filter is shown, more poles may be required in order to achieve the required isolation of the activation signals without affecting the audio frequency response. Also, it may be desirable to include the isolation filter within the feedback loop of the audio output amplifier as shown in order to minimize the impact to the audio frequency response.

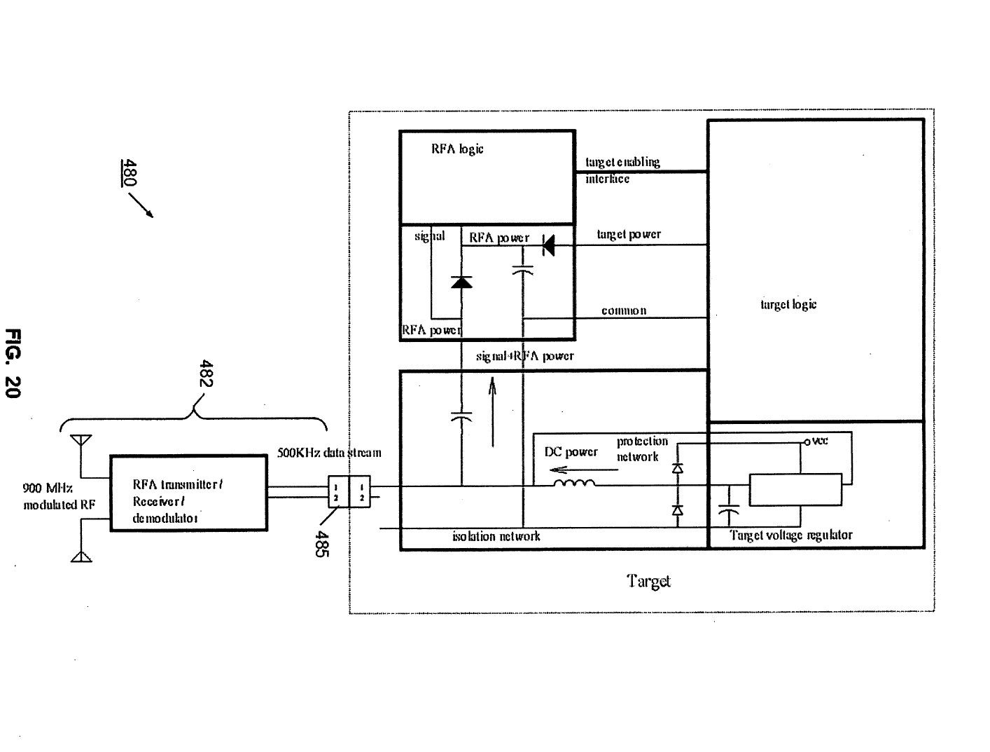

FIG. 20 illustrates an electronic device 480 with an external antenna member 482 coupled to a connector 385 for a device which provides a source of DC power for other devices, i.e. Power-Source Equipment (PSE). Because of the large output capacitance associated with sourcing DC power, the isolation network may not require its own filter capacitor. The added inductor in combination with the PSE output filter capacitor, form the isolation network to keep the target circuitry from loading the RFA signal. As in the case of the audio amplifier output, it may be desirable to include the isolation network in the feedback loop of the output voltage regulator thereby minimizing the effect of the isolation network on the normal operation of the power sourcing equipment.

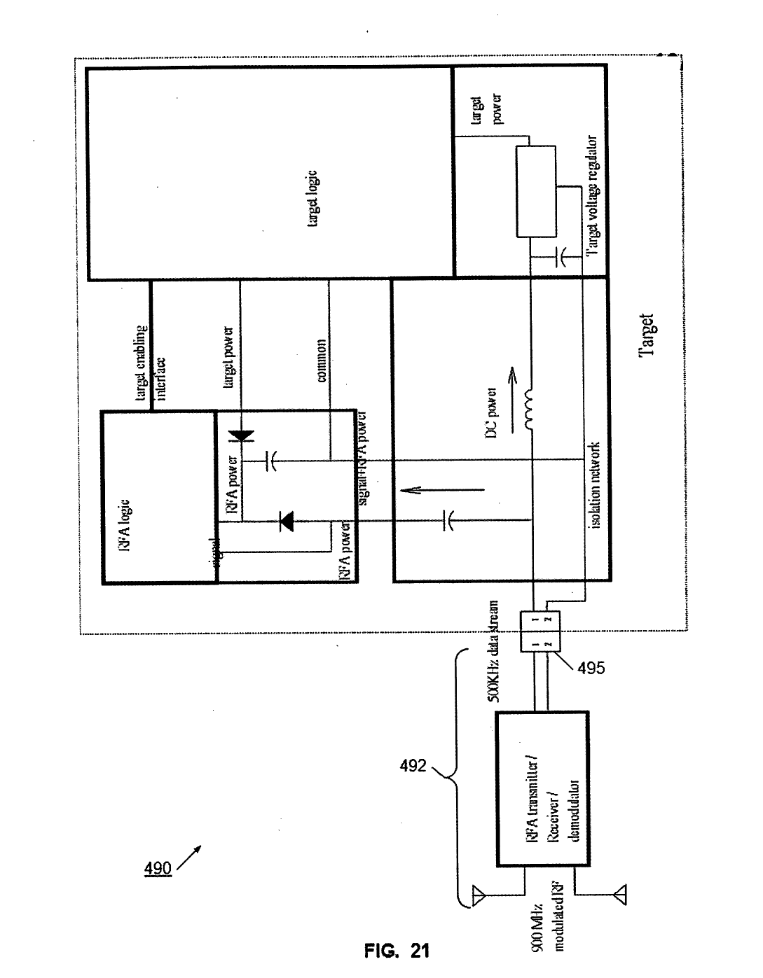

FIG. 21 illustrates an electronic device 490 with an external antenna member 492 coupled to a connector 495 for a target which is powered by an external DC supply, such as an AC wall socket regulated DC supply. This type of target is referred to as a Powered Device (PD). As shown, the isolation network for the target power supply consists of a single inductor. The target power supply's input filter capacitor is used with this inductor to form a low pass filter which provides a high impedance to the activation signals, and keeps the activation signal out of the power supply circuitry. When the target is powered by an external DC source in normal operation, the inductor helps attenuate external high frequency noise. Because the input filter capacitor will normally be quite large, (high capacitance), clamp diodes may not be needed.

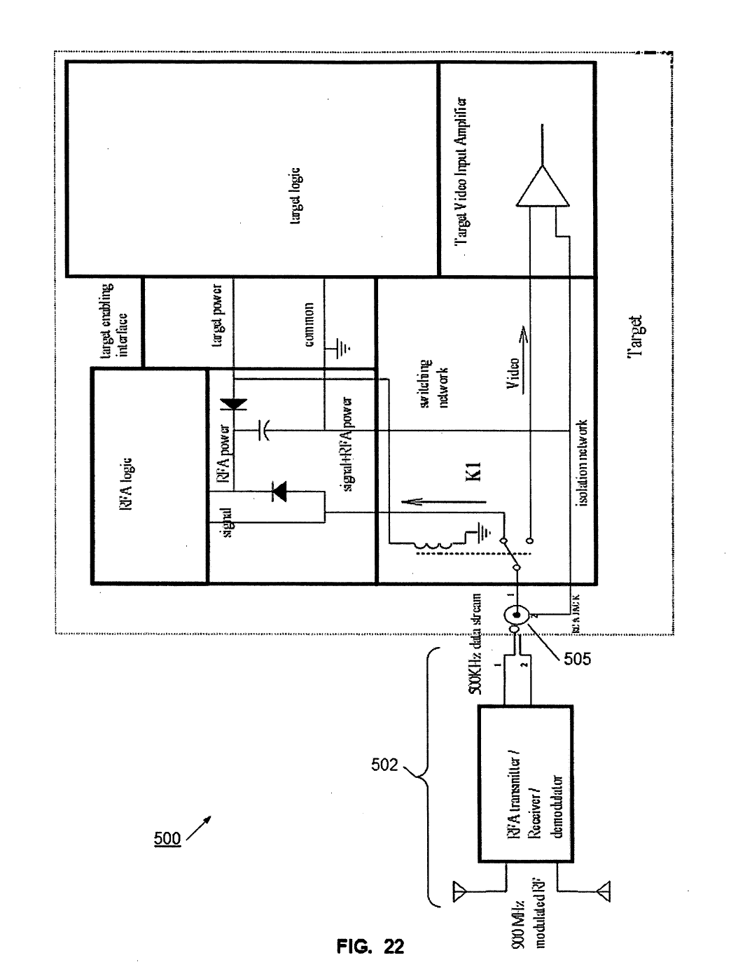

FIG. 22 illustrates an electronic device 500 with an external antenna member 502 coupled to a video input 505. Because video signals overlay the activation signals in the frequency domain, passive filter isolation networks are not effective at isolating the signals. In these situations, isolation may be achieved by a switching device such as a relay or solid state switch, which is energized by target power during normal target operation. During activation, when the target is un-powered, relay K1 routes the activation signals to the activation circuitry. When the target is powered, it energizes relay K1, which routes the video signal to the normal target circuits rather than the activation input. This provides a very high degree of isolation between activation signals and target circuitry. This approach is feasible in all systems in which the connector being used is not the source of power for the target. It may be desirable to use a solid state switch rather than a relay to accomplish signal switching. In these cases, two solid state switches may need to be connected back to back in series so that their substrate diodes do not conduct when the target is powered off, and activation signals are present.

Many other target connectors can be utilized as the activation signal port using the techniques described above and depicted in FIGS. 17 to 22. Many connectors have unused pins, which can be used for activation signals without any isolation networks. Connectors which fall into these categories include, but are not limited to: USB ports, Ethernet ports, mouse ports, keyboard ports, PCMCIA ports, memory card ports, S video ports, game ports, serial ports, parallel ports, phone jacks, and battery connectors.

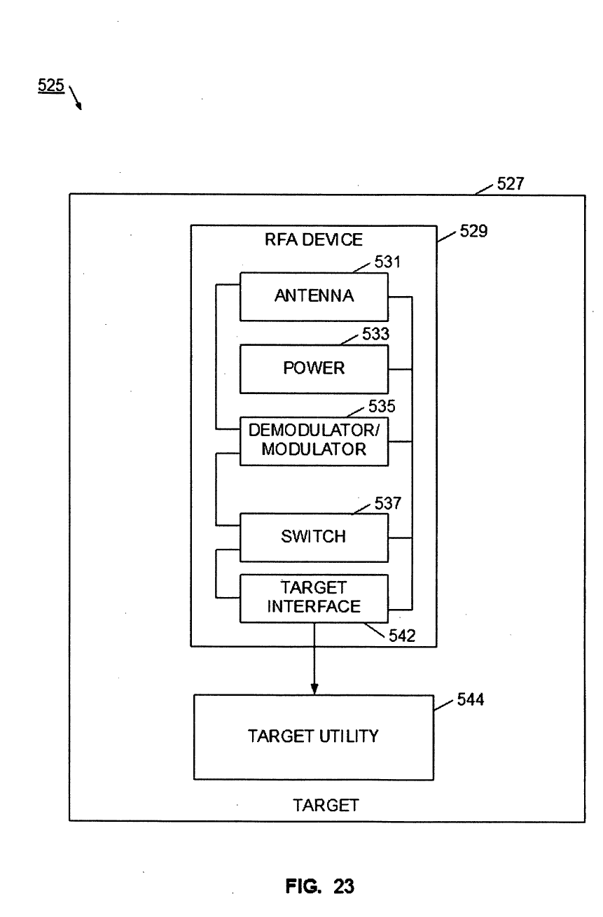

Referring now to FIG. 23, a target 525 is illustrated. Target 525 has an RFA device installed inside the housing 527 of target 525. When target 525 was manufactured, the RFA device had its switch set to disable or substantially compromise the utility of the target. In this way the target's utility 544 would be unavailable if the target is stolen. The utility can be, for example, the ability to power-on the target, or to fully use the features or benefits of the target device. In another example, the utility may be the aesthetic appeal of the target. In another example, the utility may be the ability for another device, such as a DVD player or a game console, to read information stored on the target. The RFA device 529 has an antenna 531 and a demodulator/modulator 535 for receiving an RF signal from an RF source. In one example, the RF source is an RF transmitter at a point-of-sale terminal. The RFA device also has a power source 533. The power source 533 may be associated with the demodulator/modulator circuit 535 for converting RF power to a usable electrical energy. In another example, power 533 may be a battery, or may be connected to an operational power source for target 525. The RFA device has a switch 537 that has been set during manufacturing to a position that causes the target's utility 544 to be unavailable. The target utility 544 communicates with switch 537 through a target interface 542. The target interface may be, for example, a power line, a logic line, a memory line, a multi-line interface, or an internal optical link. It will be appreciated that other ways may be used to interface the target utility to the switch 537.

It will also be appreciated that the target interface 542 may be dependent upon the particular physical construction of the RFA device 529. For example, the RFA device may be constructed as an integrated circuit, in which case the target interface 542 may be a pin on an IC package device. The target interface 542 may couple the IC pin to one of the internal layers of a PC board to reduce tampering. In another example, the RFA device is a surface mount package. In this case, the target interface 542 will be constructed as a pad or terminal interface on the surface mount package. It will be appreciated that other types of target interfaces may be used dependent on the physical packaging for the RFA device.

In use, a consumer may take target 525 to a point-of-sale terminal, pay for the target, and have the point-of-sale clerk confirm that the user is authorized to have an activated target. At that point, the point-of-sale terminal may transmit an RF signal to antenna 531. Antenna 531, cooperating with the demodulator modulator 535 and power source 533, receives an RF signal sufficient to change switch 537 to a different state. In one example, switch 537 is a fuse which is blown by the application of power 533. In another example, switch 537 is a change effecting device such as an electro-optical material. Upon the application of an electrical current, the electro-optical material changes state, which may be detected by the target utility through the target interface. Once the switch 537 is in its operational state, the next time the target utility 544 is activated, it will detect the new position of the switch 537 and allow the target to fully operate. Accordingly, the target 525 was shipped through the distribution channels in a disabled state, and upon authorization from a point of sale system, was activated using an RF signal. In some arrangements, a confirmation signal may be sent back to the point-of-sale to device to confirm activation activity.

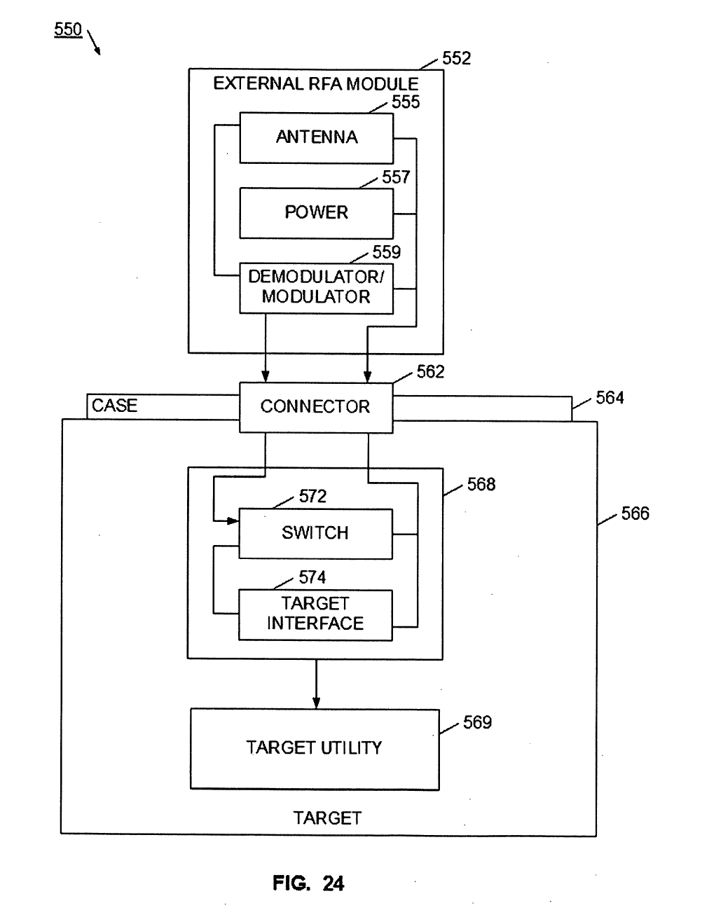

Referring now to FIG. 24, another target 550 is illustrated. Target 550 is similar to target 525 previously described, so will not be described in detail. Target 550 has a housing 566 that has a case 564 which shields the internal RFA device 568 from RF signals. Because of the shielding, the antenna member 552 is constructed to be attached external to case 564. More particularly, external RFA module 552 has an antenna structure 555, a power structure 557, and the demodulator modulator structure 559. The antenna member 552 may be constructed to couple through connector 562 to the internal RFA device 568. The connector 562 may be designed specially to receive the external antenna module 552, or may be a standard connector, as described with reference to FIGS. 17 to 22. Connector 562 enables a received RF activation signal to be received in to switch 572, which then enables target utility 569 to determine whether or not the switch is in its active state. More particularly, the target utility 569 communicates through target interface to switch 572. The internal RFA device 568 may be constructed as an integrated circuit DIP, a surface mount package, or another component or module structure. After target 550 has been activated, the antenna member 552 may be removed from the connector and disposed. In some arrangements, a confirmation signal may be sent back to the point-of-sale to device to confirm activation activity.

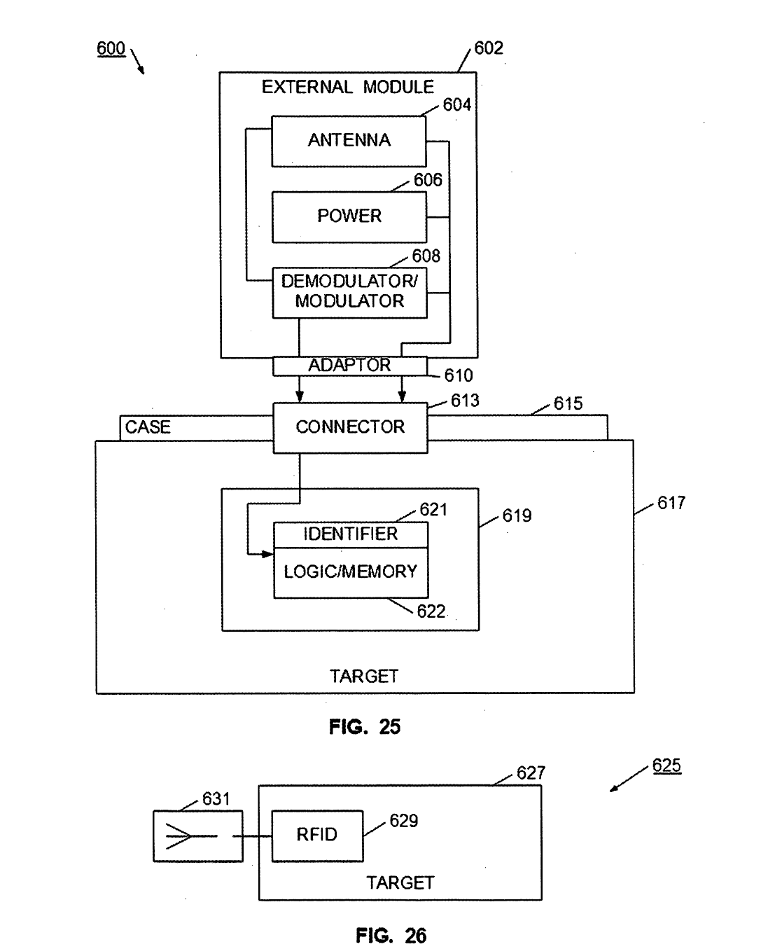

Referring now to FIG. 25, another target device 600 is illustrated. Target device 600 has a housing 617 that has a case 615 that provides RF shielding. Therefore, any RF ID device placed inside case 615 would not be able to sufficiently receive an RF signal. Accordingly, an external antenna module 602 is positioned to efficiently receive RF communication signals from an RF reader through its antenna 604. The antenna cooperates with the demodulator modulator 608 to pass power or data signals to an RF ID portion 619. The RF ID portion 619 may be placed inside the target housing, or may be placed in another protected position. For example, the RF ID portion 619 may be placed inside the target's packaging, while the external antenna module 602 may be placed on the outside of the package. The external module 602 may connect to the RF ID portion 619 in a variety of ways. For example, the external model 602 may connect to a connector on the device. The adapter 610 may be constructed to cooperate with an existing connector 613 on the device, or may be specially constructed for the RF ID application. On use, target 600 is taken by a consumer to a point-of-sale checkout terminal. At the point-of-sale checkout terminal an RF reader makes an RF inquiry to the antenna 604. Antenna 604 cooperates with the demodulator modulator 608 to retrieve an identifier 621 stored in logic/memory block 622. Preferably, the RF reader also provides RF power source 606 for powering logical and transmission functions. The identifier 621 is wirelessly communicated back to the RF reader through antenna 604. By separating the RF ID portion 619 from its antenna portion 602, a more effective and robust RF ID system is enabled.

Referring now to FIG. 26, an RF ID enabled device 625 is illustrated. RF ID device 625 has a target package 627. An RF ID 629 is attached to the target or installed within the target. However, the RF ID portion 629 is shielded from effective RF signals, so an antenna portion 631 is separately provided. The antenna portion 631 may be installed on another area of the target having better RF characteristics, or may be installed on a different area of target packaging. The RF ID antenna portion 631 may be disposable, or may be more permanently affixed to facilitate warranty or repair services.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A radio frequency controller device, comprising:
a target interface;
a switch device connected to the target interface;
conditional circuitry operatively connected to the switch;
a modulator/demodulator connected to the conditional circuitry; and
an antenna connected to the modulator/demodulator r.

2. The radio frequency controller device according to claim 1, wherein the radio frequency controller device is constructed as an integrated circuit DIP, a surface mount package, or packaged as a silicon die.

3. The radio frequency controller device according to claim 1, further comprising:
a low-power RF circuit portion:
a full-power circuit portion;
a shared circuit portion; and
wherein the low power circuit portion sets the state of the shared circuit portion, and the state of the shared circuit portion affects the output of the full-power circuit portion.

4. The radio frequency controller device according to claim 3, wherein:
the low-power RF circuit portion comprises:
the antenna;
the modulator/demodulator;
the conditional circuitry;
the full-power circuit portion comprises:
the target interface
the shared circuit portion comprises:
the switch; and
wherein the low power circuit portion sets the state of the switch, and the state of the switch affects the output of the full-power circuit portion.

5. The radio frequency controller device according to claim 1, further comprising:
an internal module comprising:
the memory;
the conditional circuitry;
the switch; and
the target interface;
an external module comprising:
the antenna; and
the modulator/demodulator; and
a connection between the internal module and the external module.

6. The radio frequency controller device according to claim 1, further comprising:
an internal module comprising:
the memory;
the conditional circuitry;
the switch;
the target interface; and
the modulator/demodulator;
an external module comprising:
the antenna; and
a connection between the internal module and the external module.

7. The radio frequency controller device according to claim 5 or 6, further including a power source for powering the internal module.

8. The radio frequency controller device according to claim 5 or 6, further including a power source for powering the external module.

9. The radio frequency controller device according to claim 5 or 6, wherein the external module further comprises a mating connector, the mating connector constructed to mate with a connector selected from the group consisting of: audio input connector, audio output connector, video input connector, video output connector, data connector, network connector, AC power connector, DC power connector, battery power connector, USB port, Ethernet port, mouse port, keyboard port, PCMCIA port, memory card port, S video port, game port, serial port, parallel port, phone jack, standard connector, custom connector, and battery connector.

10. The radio frequency controller device according to claim 5 or 6, wherein the connection is constructed to couple to a power line, a data line, a logic line, or an RF signal line.

11. The radio frequency controller device according to claim 5 or 6, further comprising:
a connector for coupling the internal module to the external module; and
wherein the internal module is in the connector.

12. The radio frequency controller device according to claim 1, wherein the antenna is detachable.

13. The radio frequency controller device according to claim 1, wherein the target interface is a logic line, a memory, a control line, or a power line.

14. The radio frequency controller device according to claim 1, wherein the target interface is a transparent substrate, and the switch is a change effecting device on the transparent substrate.

15. The radio frequency controller device according to claim 14, wherein the change effecting device is an electrically switchable optical material disposed on the transparent substrate.

16. The radio frequency controller device according to claim 1, wherein the switch is change effecting device, and the change effecting device is a memory value, an electronic switch, an electrical switch, a mechanical switch, a fuse, an electromechanical device, a chemical change, a electro-optical filter, on optical emitter, an audible emitter, an EM emitter, or a power controller.

17. The radio frequency controller device according to claim 1, further comprising a memory storing a key for use by the conditional circuitry;

18. The radio frequency controller device according to claim 1, wherein the conditional circuitry is a logic circuit, a processor, a microprocessor, a microcontroller, or a comparison circuit.

19. The radio frequency controller device according to claim 1, wherein the memory is non-volatile, is non-erasable, non-alterable, or cannot be externally read.

20. The radio frequency controller device according to claim 1, wherein power is supplied by the modulator/demodulator, a battery, or a power connection to a target device.

21. The radio frequency controller device according to claim 1, further comprising:
a housing; and
attachment means for attaching to a target.

22. The radio frequency controller device according to claim 21, wherein the attachment means is an adhesive, a bonding pad, releasable mechanical connection, locking mechanical connection, or circuit pins.

23. The radio frequency controller device according to claim 1, further comprising additional memory for storing data received through the antenna, additional memory for counting activations, or additional memory for use by the conditional circuitry.

24. The radio frequency controller device according to claim 1, further comprising a matching network circuit connected between the antenna and the modulator/demodulator.

25. An RF device, comprising:
a switch constructed to couple to a data, logic, or power line in a target device;
a low-power circuit constructed to set the state of the switch responsive to a received RF signal;
a power source coupled to the low-power circuit and available to power the low-power circuit when the target is in a power-off state; and
wherein the state of the switch is selectably set when the target is in the power-off state.

26. The RF device according to claim 25, further including a remote RF antenna coupled to the low-power circuit.

27. The RF device according to claim 25, further including a removable RF antenna coupled to the low-power circuit.

28. The RF device according to claim 25, wherein the switch is a change effecting device.

29. The RF device according to claim 25, wherein switch is coupled to the target device using an electrical, electronic, optical, acoustic, electromagnetic, RF, or IR transmission.

30. The RF device according to claim 25, wherein switch is selectably set to either an open state or a closed state, and is constructed to coupled to a reset line of an electronic device.

31. An RF controlled target device, comprising:
an RF device, comprising:
a switch coupled to operating circuitry in the target device;
a low-power circuit constructed to set the state of the switch responsive to a received RF signal;
a power source coupled to the low-power circuit and available to power the low-power circuit when the target is in a power-off state; and
wherein the state of the switch is selectably set when the target is in the power-off state.

32. The RF controlled target device according to claim 31, wherein the operating circuitry operates at a level of utility responsive to the state of the switch.

33. The RF controlled target device according to claim 31, further including an isolation switch between the low power circuit and the operating circuitry.

34. The RF controlled target device according to claim 33, wherein the isolation switch transitions from an open state to a closed state responsive to the target powering on.

35. The RF controlled target device according to claim 31, wherein the RF device further includes an RF antenna mounted on a remote antenna member and coupled to the low-power circuit.

36. The RF controlled target device according to claim 35, further including a connector on the target for receiving the antenna member.

37. The RF controlled target device according to claim 36, wherein the connector is a dedicated connector for electrically connecting the RF antenna to the low-power circuit.

38. The RF controlled target device according to claim 36, wherein the connector is a standard functional connector that connects the RF antenna to the low-power circuit and also connects to the operating circuitry in the target.

39. The RF controlled target device according to claim 38, wherein the connector is selected from the group consisting of: audio input connector, audio output connector, video input connector, video output connector, data connector, network connector, AC power connector, DC power connector, battery power connector, USB port, Ethernet port, mouse port, keyboard port, PCMCIA port, memory card port, S video port, game port, serial port, parallel port, phone jack, standard connector, custom connector, and battery connector.

40. The RF controlled target device according to claim 31, wherein the target is selected from the group consisting of: computer; game console; integrated circuit chip; processor; camera; television; phone; PDA (personal data/digital assistant); calculator; portable music, video, or game player; electronically controlled appliance or tool; watch; printer; fax machine; machinery, instrument; stereo; DVD player; video receiver; and computer peripheral.

41. An RF controlled target device, comprising:
a connector on the target;
operating circuitry connected to a connector, the operating circuitry configured to receive operating signals through the connector at a first frequency;
a switch device, comprising:
a change effecting device coupled to the operating circuitry in the target device;
a low-power circuit connected to the connector, and constructed to set the state of the change effecting device responsive to a change signal;
a power source coupled to the low-power circuit and available to power the low-power circuit when the target is in a power-off state; and
wherein the state of the switch is selectably set when the target is in the power-off state.

42. The RF controlled target device according to claim 41, further including an antenna module coupled to the connector and providing the change signal at a second frequency.

43. The RF controlled target device according to claim 42, wherein the antenna module further includes a demodulator for providing the change signal at a lower frequency then a received RF signal.

44. The RF controlled target device according to claim 42, wherein the antenna module further includes a demodulator for providing the change signal at a frequency in the range of about 1 Hz to about 100 MHz.

45. The RF controlled target device according to claim 42, further including an isolation network for routing substantially all the change signal to the low-power circuit and substantially all of the operating signals to the operating circuitry.

46. The RF controlled target device according to claim 45, wherein:
the connector is an AC power connector;
the operating circuitry is a power supply; and
the isolation circuit is a set of capacitors and a set of inductors, and when AC power is provided at the connector, the AC power is routed to the power supply; and
when the antenna member is provided at the connector, the change signal is routed to the low power circuit.

47. The RF controlled target device according to claim 45, wherein:
the connector is an audio input port;
the operating circuitry is an audio circuit operating on signals in an audio frequency range; and
the isolation circuit has a shunt capacitor to short the higher frequency change signal from audio circuit and clamping diodes to protect the audio circuit from change signal current.

48. The RF controlled target device according to claim 45, wherein the isolation circuit further includes a diode that is reverse biased by the target's power supply so that audio band signals are not transmitted to the low-power circuit when the power supply is on.

49. The RF controlled target device according to claim 45, wherein:
the connector is an audio output port;
the operating circuitry is an audio circuit operating on signals in an audio frequency range; and
the isolation circuit has an audio-band pass filter to block the higher frequency change signal from the audio circuit and clamping diodes to protect the audio circuit from change signal current.

50. The RF controlled target device according to claim 49, wherein the isolation circuit further includes a diode that is reverse biased by the target's power supply so that audio band signals are not transmitted to the low-power circuit when the power supply is on.

51. The RF controlled target device according to claim 45, wherein:
the connector is a DC power connector;
the operating circuitry is a DC power line; and
the isolation circuit includes an inductor connected to the power line, and when DC power is provided at the connector, the DC power is routed to the power line; and when the antenna member is provided at the connector, the change signal is blocked from the power supply.

52. The RF controlled target device according to claim 51, wherein the isolation circuit further includes a diode that is reverse biased by the target's power supply so that DC power is not transmitted to the low-power circuit when the power supply is on.

53. The RF controlled target device according to claim 45, wherein:
the connector is a video input port for receiving a video signal;
the operating circuitry is a video circuit; and
the isolation circuit is a switch device acting responsive to the target's power supply, such that the switch device routes the change signal to the low-power circuit when the target is in a power-off state, and routes the video signal to the video circuit when the target is in a power-on state.
